(19) United States
(12) Patent Application Publication
(10) Pub. No.: US 2025/0201128 A1
(43) Pub. Date: Jun. 19, 2025

(54) SYSTEMS AND METHODS FOR DYNAMIC VEHICLE PLATOONING

(71) Applicant: UNIVERSITY OF SOUTH FLORIDA, Tampa, FL (US)

(72) Inventors: Srinivas KATKOORI; Omkar DOKUR, Tampa, FL (US); Gustavo OLENSCKI, Tampa, FL (US)

(21) Appl. No.: 18/986,688

(22) Filed: Dec. 18, 2024

Related U.S. Application Data
(63) Continuation-in-part of application No. 18/986,578, filed on Dec. 18, 2024.
(60) Provisional application No. 63/611,695, filed on Dec. 18, 2023.
(60) Provisional application No. 63/611,700, filed on Dec. 18, 2023.
(60) Provisional application No. 63/611,706, filed on Dec. 18, 2023.
(60) Provisional application No. 63/611,712, filed on Dec. 18, 2023.
(60) Provisional application No. 63/611,716, filed on Dec. 18, 2023.

(51) Int. Cl. G08G 1/00; B60W 10/04; B60W 10/20; B60W 30/16

(52) U.S. Cl. CPC G08G 1/22; B60W 10/04; B60W 10/20; B60W 30/16; B60W 2520/10; B60W 2554/4041; B60W 2554/4045; B60W 2554/802; B60W 2555/20; B60W 2556/65; B60W 2710/20; B60W 2720/106; B60W 2754/30

(57) ABSTRACT

Systems and methods are provided herein for implementing dynamic, scalable platoon formations for traveling vehicles. Such platoons may be formed and modified on the fly by vehicles that have varying sensing or autonomy capabilities. Platoons may be negotiated among available vehicles, to designate roles including global platoon leader, local leader(s), and platoon member(s). While the platoons are in place and the vehicles traveling in coordination, platoon members may depart the platoon, and the remaining members may re-allocate roles among the remaining members.

### CROSS REFERENCE TO RELATED APPLICATIONS

This application claims priority to U.S. provisional patent application Nos. 63/611,695, 63/611,700, 63/611,706, 63/611,712, and 63/611,716, each filed Dec. 18, 2023, as well as U.S. application Ser. No. 18/986,578, filed on Dec. 18, 2024, the entire contents of which are incorporated herein by reference.

### STATEMENT OF GOVERNMENT SUPPORT

N/A

### BACKGROUND

According to the US Environmental Protection Agency (EPA), transportation is the major source of greenhouse gas emissions, accounting for 27% of all emissions in 2020. For example, the American Trucks Association (ATA) reported that in 2020, trucks used 9.0 billion gallons of gasoline and 35.8 billion gallons of diesel fuel leading to large amounts of greenhouse gases. As a result, there are significant fuel costs and greenhouse gas emissions in roadway vehicle transportation (whether passenger transportation, shipping, etc.), both of which can be reduced if fuel economy is further enhanced.

One approach to improving fuel efficiency is vehicle platooning, where two or more vehicles drive closely together with smaller gaps between them to achieve lower aerodynamic resistance, can boost fuel economy. However, while this approach is recognized as efficient, it is difficult to accomplish in practice. In some cases, it is done entirely manually by drivers who may lack information about the other vehicles' movements and goals. Automated or autonomous platooning has not yet been implemented, given a number of obstacles and difficulties in deploying such a system.

For example, expensive and sometimes-unreliable equipment such as LIDAR, optical cameras, and other inter-vehicle sensors may be in use in some vehicles, but can vary tremendously manufacturer-to-manufacturer and even vehicle-to-vehicle. Thus, any automatic or autonomous platooning system would encounter interoperability issues right away (or be limited to only identical vehicle make/models/capabilities. Additionally, such sensors are affected by adverse weather, like rain, snow, fog, sunlight glare, or other interference, and the degree to which any given vehicle is affected may not be the same across multiple types of vehicles. And, even if a platoon were created of only identical vehicles, weather and interference conditions may not affect each vehicle identically at the same time.

Furthermore, there has been no suggestion or proposal for automatic/autonomous systems that could dynamically be created and dissolved on a roadway. Rather, to date, it has been assumed that autonomous platooning would require a priori setup, with a dedicated platoon structure put in place in advance with a designated leader and a designated number of followers. Thus, the ability to platoon on any given roadway would be limited to only groups of vehicles that start out driving together, so even if such a system were deployed it would be significantly limited in use and not scalable.

Therefore, it would be desirable to provide systems and methods that can support ad hoc, dynamic platooning of a heterogeneous mixture of vehicles in which (1) the vehicles need not have common sensing capabilities; (2) the systems and methods can maintain the platoon even in adverse conditions; and (3) the platoon is capable of scaling dynamically, by allowing vehicles to join or leave the platoon while in transit, and without need of pre-departure coordination of collaborating vehicles.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some aspects, the present disclosure can provide a method for dynamically creating and scaling a vehicle platoon formation, comprising: determining a platoon-ready status of a first vehicle, while the first vehicle is driving on a route segment; broadcasting a platoon intent message via a DSRC transmission; receiving a response to the platoon intent message from a second vehicle; negotiating a platoon formation via communications directly between the first vehicle and second vehicle over DSRC transmissions, the platoon formation defining a platoon leader and a platoon member from among the first vehicle and second vehicle; broadcasting a platoon available message via a DSRC transmission; receiving a response to the platoon available message from a third vehicle; determining whether the third vehicle should be admitted to the platoon formation, based on information regarding a status of the third vehicle and the route segment; if a determination is made that the third vehicle should be admitted to the platoon formation, broadcasting a platoon join instruction to the third vehicle via a DSRC transmission, and: designating a vehicle member of the platoon formation as a local leader; instructing another vehicle member of the platoon formation to perform a maneuver to commence following the local leader; and if a determination is made that the third vehicle should not be admitted to the platoon formation, broadcasting a message to the third vehicle declining to admit the third vehicle to the platoon formation, and continuing to broadcast the platoon available message.

In further aspects, the present disclosure can provide a system, device, and/or vehicle configured to implement dynamic and scalable platooning, the host vehicle comprising: a user interface; a local communication transceiver; (in the case of a system or vehicle) at least one environment sensor affixed to the host vehicle so as to monitor the host vehicle's surroundings for nearby objects; a processor; (in the case of a system or vehicle) a drive autonomy controller connected to control at least one of a steering system or an acceleration system of the host vehicle in response to instructions from the processor; and a memory having stored thereon software which, when executed by the processor, causes the host vehicle to: determine a platoon readiness state of the host vehicle; broadcast a platoon intent message via the local communication transceiver; receive a platoon intent message from a first nearby vehicle via the local communication transceiver; determine whether to form a platoon with the first nearby vehicle, based on: at least one platoon suitability requirement; information sent by the first nearby vehicle regarding a drive status of the first nearby vehicle; and information stored on the memory regarding current status of the host vehicle; when the determination indicates that a platoon with the first nearby vehicle should be formed, negotiate a platoon structure with the first nearby vehicle, the platoon structure comprising: which of the host vehicle or first nearby vehicle will be platoon leader of the platoon; an acceptable speed for the platoon; an acceptable intervehicle distance for the platoon; a common route for the platoon; and a setting indicative of whether the platoon will accept future additional members; and when the determination indicates that a platoon with the first nearby vehicle should not be formed, resume broadcasting the platoon intent message via the local communication transceiver.

### BRIEF DESCRIPTION OF THE DRAWINGS

The foregoing features of embodiments will be more readily understood by reference to the following detailed description, taken with reference to the accompanying drawings, in which:

FIG. 1 is a conceptual drawing of layers and devices within an IoV framework.

FIG. 2 is a block diagram showing an example of vehicles within a platoon.

FIG. 3 is a flow chart illustrating example steps or actions relating to platoon formation or joining, in accordance with various methods herein.

FIG. 4 is a flow chart illustrating example steps or actions that may be taken by a platoon member, in accordance with various methods herein.

FIG. 5 is a flow chart illustrating example steps or actions that may be taken by a platoon leader, in accordance with various methods herein.

FIG. 6 is a block diagram that depicts certain concepts of hardware implementations according to various embodiments.

FIG. 7 is conceptual flowchart of phases of platooning according to an example embodiment used for a validation.

FIG. 8 is conceptual flowchart of an early phase of platooning according to an example embodiment used for a validation.

FIG. 9 is conceptual flowchart of cooperative actions of vehicles in an early phase of platooning according to an example embodiment used for a validation.

FIG. 10 is conceptual flowchart of an early phase of platooning according to an example embodiment used for a validation.

FIGS. 11A, 111B, and 11C are illustrative diagrams of potential vehicle positionings of platoon members.

FIG. 12 is conceptual flowchart of a driving phase of platooning according to an example embodiment used for a validation.

FIG. 13 is conceptual flowchart of phases of multi-vehicle platooning according to an example embodiment used for a validation.

FIG. 14 is conceptual flowchart of cooperative actions of vehicles in an early phase of multi-vehicle platooning according to an example embodiment used for a validation.

FIG. 15 is conceptual flowchart of an early phase of multi-vehicle platooning according to an example embodiment used for a validation.

FIG. 16 is conceptual flowchart of a driving phase of multi-vehicle platooning according to an example embodiment used for a validation.

FIG. 17 is conceptual flowchart of a driving phase of multi-vehicle platooning according to an example embodiment used for a validation.

FIG. 18 is conceptual diagram of a simulation tool, used for a validation.

FIG. 19 is an image of a simulation of PM behavior in a two-vehicle platoon, used for a validation.

FIG. 20 is an image of a simulation of PM behavior in a two-vehicle platoon, used for a validation.

FIG. 21 is an image of a simulation of PM behavior in a two-vehicle platoon, used for a validation.

FIG. 22 is an image of a simulation of vehicle behavior in an early phase of a three-vehicle platoon, used for a validation.

FIG. 23 is an image of a simulation of PM behavior in a three-vehicle platoon, used for a validation.

FIG. 24 is an image of a simulation of PM behavior in a three-vehicle platoon, used for a validation.

FIG. 25 is an image of a simulation of PM behavior in a three-vehicle platoon, used for a validation.

### DETAILED DESCRIPTION

The following description will provide a disclosure of various features, approaches, and aspects of example systems and methods that can overcome the limitations described above, and allow for more usable, inter-operable, scalable, dynamic, robust, and effective platooning of vehicles. First, a general description will be provided of aspects of technologies that may be utilized in systems and methods of the present disclosure. Second, an overview of illustrative system/hardware architectures will be provided along with an overview of a framework for deploying certain processes and algorithms of the present disclosure. Third, a description of the inventors' experiments and validation studies will be provided.

### Terminology and Technologies

While, as described above, vehicle sensing capabilities have been a substantial consideration in driver assistance and autonomous vehicle approaches, the inventors have determined that utilizing vehicle data/informational connectivity presents a more robust platform that can be leveraged for supporting vehicle platooning. Thinking of vehicles as smart devices, such as treating vehicles as IoT edge devices, can address a number of issues precluding the successful development of vehicle platooning platforms.

The term “Internet of Things” (IoT) refers to the data sharing between physical devices connected via the Internet (or similar local networks that may be connected to the Internet). The number of physical devices that are leveraging connection to the Internet in the IoT field is rising quickly. However, to date, most research and develop in this area has focused on small, resource-constrained, dedicated-purpose devices, such as appliances, camera systems, smart home devices, etc.

Devices that operate within the IoT architecture can be thought of as falling into one or more of three basic categorizations: 1. Edge Layer devices (Contains edge nodes, which are smart objects, sensors, and actuators). IoT devices in this category are generally physical devices that perform some task (e.g., sensing, display/notifications to users, etc.) and, as a result, perform some computation on their own, also known as edge computing. 2. Fog Layer devices (Contains network-connected communication and processing units also known as fog nodes). Using fog nodes, data from edge nodes (which, themselves, may not be directly connected to the Internet, but rather rely on a Fog Layer device for Internet connectivity and/or other support) is uploaded to the cloud which is also known as fog computing. 3. Cloud Layer devices (e.g., virtual servers, physical servers, cloud resources, web-based portals, etc.). In this layer, applications and analytics are built using data from fog nodes.

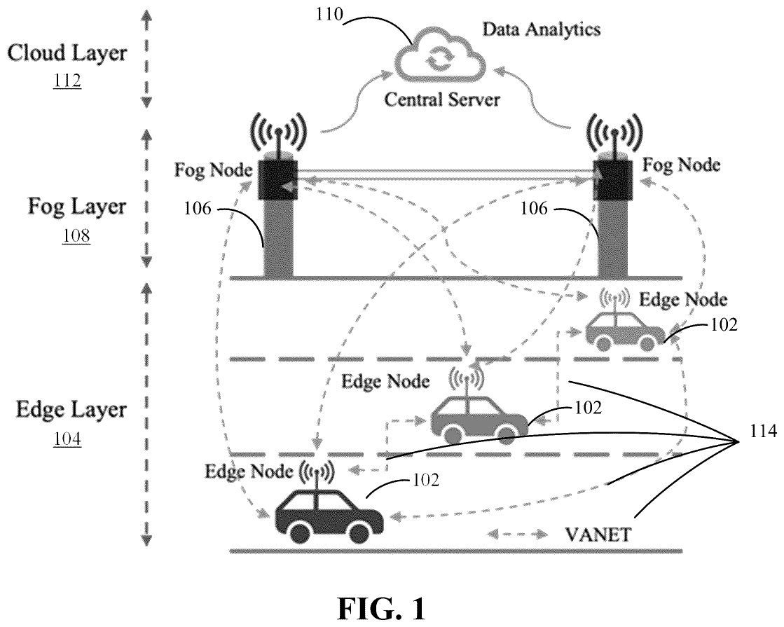

As shown in FIG. 1, the IoT concept mentioned above can be applied to vehicles, where each vehicle can function as an edge node. However, with the classic approach of considering edge nodes as the bottom “tier” of the IoT hierarchy, requiring fog nodes and/or a cloud layer, several limitations still exist. For example, as shown in FIG. 1, each vehicle 102 may be part of an Edge Layer 104, such that they are each connected to one or more fog nodes 106 of a Fog Layer 108. These fog nodes 106 would be physical infrastructure, such as roadside transceivers, that provide instructions to the vehicles 102. The fog nodes 106, would then be connected to a centralized server 110 of a cloud layer 112, which coordinates the activity instructions sent to the vehicles 102. However, this approach still relies on several factors that limit its ability to overcome the limitations described above. For example, significant infrastructure is required, and each vehicle still relies on its own sensors to platoon, even though the vehicle is taking instructions from a centralized server. Each vehicle that is not directly connected to the fog layer device would be reliant on the intermediate vehicle, thus making it necessary that the two vehicles have the same origination and destination points and will travel together continuously.

Vehicle-to-vehicle communication (rather than solely vehicle-to-fog layer device) can help improve on the foregoing approach. As one example, platooning achieved through an IoT regime (e.g., Internet of Vehicles (IoV)), where vehicles and roadside systems are connected through vehicular ad hoc networks (VANETs) 114 as shown can be utilized to extend reach of fog layer devices, and thereby somewhat reduce the need for extensive infrastructure. Using vehicle-to-everything (V2X) connections, each vehicle in the IoV is considered a smart object that is installed with sensor platforms, processing facilities, control units, and storage. However, even using vehicle-to-vehicle communication to extend fog systems does not overcome the limitations described above. In fact, in some ways it could exacerbate some of the issues, as a wide range of industry sectors, including transportation, automobile manufacturing, energy, automation, software, and information and communication technology, would need to coordinate to achieve such a regime, and all would be significantly impacted by this approach.

One way in which vehicle-to-vehicle communication can take place is through platforms that utilize Dedicated Short Range Communication. Dedicated Short Range Communication (DSRC) is a low latency, wireless communication technology that is usable for vehicle-to-vehicle (V2V) and vehicle-to-infrastructure (V2I) communication in transportation systems. It operates in the 5.9 GHz frequency band, designated for automotive safety and mobility applications. The DSRC platform can be more limited in range (e.g., 100 meters, 200 meters, 300-500 meters, 750 meters, 1000 meters, etc.) in comparison to cellular or similar data communication platforms, but is more robust. In the United States, the Federal Communications Commission has allocated 75 MHz of spectrum in the 5.9 GHz band exclusively for DSRC, ensuring minimal interference from other wireless devices. And, being a vehicle-to-vehicle communication platform, it is not dependent on cellular tower location or uptime, network traffic restrictions, or other infrastructure limitations. Importantly, DSRC is far more weather-independent and insulated from other interference, than sensors such as LIDAR and optical cameras.

One type of communication that occurs over DSRC is known as “Basic Safety Messages” or the “BSM” protocol. Basic Safety Messages are standardized data packets exchanged between vehicles (Vehicle-to-Vehicle, or V2V) or between vehicles and roadside infrastructure (Vehicle-to-Infrastructure, or V2I). In terms of packet communication, BSMs can have multiple parts to each packet, multiple rates of packet transmission, and/or multiple packet types. For example, one part of a packet, or packet type, may have frequently updated, safety-critical data transmitted regularly at high rates, such as vehicle position, speed, heading, acceleration, brake status, vehicle size/dimension, etc. Another part of a packet, or packet type, may contain additional, event-driven information that is transmitted whenever necessary, such as when adverse weather or interference is detected or emergency maneuvers are taken, needed, or detected. The event-drive information may include information such as path history, path prediction, event flags (hard braking, airbag deployment, etc.), environmental information, and vehicle feature and sensor states (e.g., tire pressure, wiper status, headlight status, ABS operation, AWD status, etc.).

BSMs can be transmitted at regular intervals or at dynamic intervals. For example, in some situations they may be transmitted by a given vehicle every 10 seconds, 1 second, 100 milliseconds, 10 milliseconds, etc. In other situations, they may be transmitted at dynamic intervals. For example, if no other vehicles are in range to respond, the broadcast rate may be decreased, and if other vehicles are in range they may be broadcast more frequently. The messages are generally broadcast directly to other vehicles, but may also be received by nearby infrastructure—in either case a centralized tower or server is not required.

The present disclosure can leverage the DSRC and BSM-based communication (or other similar transmission bands/protocols/transmission types) to provide a platform for enabling vehicle platooning that overcomes the limitations described above. The use of such V2V communication may be independent of, or a supplement to, other platooning protocols.

As will be described below, IoV-based platooning systems and methods of the present disclosure can enable two or more vehicles to negotiate and dynamically initiate a new platoon, before or while they are traveling, through messaging protocols like BSMs. The vehicles can determine which is the optimal vehicle to serve as the platoon leader (“PL”) and which should be a platoon member (“PM”). After successful initialization, the PL and PM can utilize their own driving systems (e.g., autonomous modes, adaptive cruise control, lane shift assistance, and other technologies) to govern their own driving—the PMs need not take their instructions from the PL and need not have any given type of sensing or driving capability. Rather, the PM may use various platoon formation and management algorithms to receive information from the PL, compute the relative position of the PL, and generate its own target velocity and destination. And, given the dynamic nature of such a cooperation among vehicles, once a platoon is formed, new vehicles can join the platoon using the same proposed algorithms and existing PMs can leave at will.

Thus, aspects of the present disclosure provide for a number of advantageous features, which may include (among others): 1. initiating platoons via V2V-based communication (e.g., over DSRC) with nearby vehicles; 2. introducing an IoV-based multi-vehicle platoon negotiation algorithm capable of handling diverse messages; 3. formulating an IoV-based multi-vehicle platoon formation algorithm, that can select a PL and designate; 4. maintaining platoons, with dynamically-changing membership, including of vehicles that have different sensing capabilities, different origin/destination points, and other heterogeneity; and 5. providing for knowledge of other members' position, speed, heading, etc. in a way that is not reliant on specific sensing capabilities and is weather/interference robust.

Furthermore, the systems and methods disclosed herein may be utilized with a variety of approaches to automated driving systems. The Society of Automotive Engineers (SAE) defines six levels of autonomy, with level zero meaning no autonomy; level one being driver assistance that controls steering or speed (e.g., adaptive cruise control); level two being partial automation, which includes simultaneous control of steering and speed (e.g., ADAS systems that combine lane-centering and adaptive cruise control); level three being conditional automation (controlling all driving tasks, under specific conditions); level four being high automation, in which the vehicle controls all driving tasks and monitors the environment without driver intervention; and level five meaning complete autonomy. Generally speaking vehicles that have level 1-6 will have a controller that is connected to control an acceleration system, a steering system, a braking system, or combinations thereof for the vehicle, in response to the vehicle's processor determining changes should be made to drive characteristics due to sensor readings or other stimuli. As will be described below, various embodiments may be usable by vehicles/drivers of any of the six levels of autonomy, including mixed groups of vehicles having different autonomy levels.

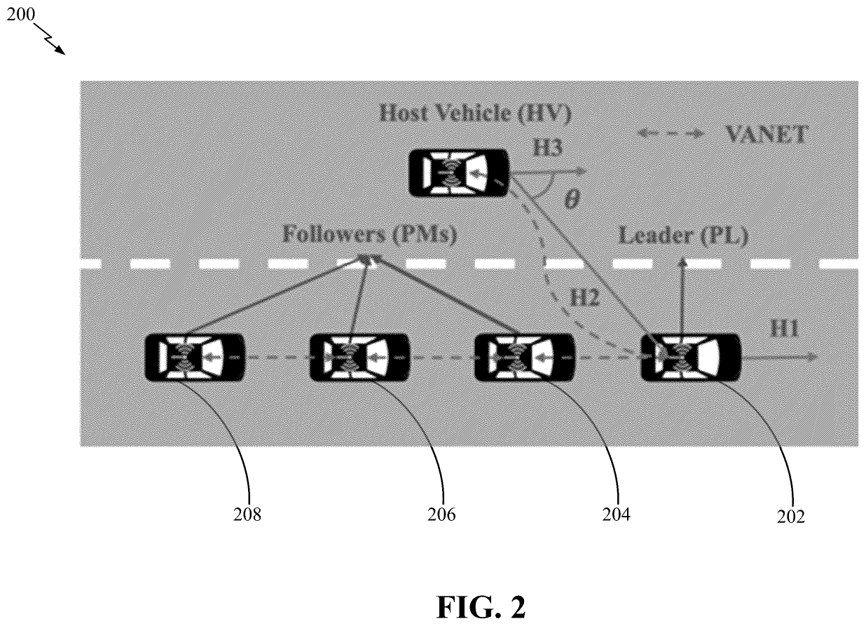

Referring now to FIG. 2, an example diagram 200 of vehicles in a platoon will be used to discuss terminology and concepts relevant to the topic of platooning, such as will be further described below. A platoon of vehicles generally includes at least two vehicles, but may include many more. One of the vehicles is desigated as the Platoon Leader (PL) 202. Usually this is the car that is furthest ahead in the direction of travel, but as described below this need not always be the case. Other vehicles are designated as Platoon Members (PM) 204-208 that follow the PL. Each PM 204-208 follows another vehicle (whether the PL or another PM) in the same lane, using a speed that maintains safe distance between the vehicles while gaining aerodynamic benefit for the PMs. The manner in which the platoon is formed, how the platoon roles (PL or PM) are determined, which lane(s) the platoon members occupy, and how the vehicles maintain their positioning relative to one another relies on some form of coordination among the vehicles. As will be described below, connected vehicle messages sent among the platoon vehicles can be utilized for these purposes in a way that allows for dynamically-forming platoons of heterogeneous vehicle composition.

Various embodiments, configurations, materials, devices, systems, methods, and techniques for unstructured pruning are disclosed herein. With respect to the devices and systems described below, certain alternative components and materials are described, none of which are intended to be limiting or required. The description of components of such devices and systems is intended to be illustrative only, and neither a minimum nor limit of the types of components that could be used in various embodiments hereof. Similarly, the methods described herein are explained with reference to optional steps and modifications, none of which are intended to be limiting or required. The methods described herein can be performed using hardware such as (or including) the devices and systems described herein but need not be implemented through such hardware except in specific examples that identify the use of such hardware.

### Example Methods for Platoon Formation, Management, and Participation

The present disclosure will now provide overview descriptions of various approaches to deploying embodiments of dynamic platooning methods. It should be understood that the processes and algorithms described below are not limiting of the scope of this disclosure, can be combined in various configurations, and may be adapted to replace, complement, and/or fit with attributes and needs of different vehicles, vehicle capabilities, roadway types, platoon goals, jurisdictional laws and requirements, etc.

In one sense, dynamic platooning can be thought of as including multiple phases, and multiple roles for vehicles within each phase. Because platoon approaches according to this disclosure can be formed, modified, and deconstructed spontaneously or dynamically (rather than being pre-planned among coordinated/co-controlled vehicles prior to departure), an initial phase may comprise procedures for locating platoon opportunities; establishing and initializing a new platoon; and/or joining a new member to an existing platoon. When a platoon has been formed, different activities and procedures may be performed by the various roles of the platoon (e.g., platoon member(s)/follower(s); platoon leader; local leader(s); etc.), as well as common actions (e.g., information exchange among the connected vehicles). Finally, when, how, and why a vehicle leaves a platoon may entail a variety of actions and procedures as well.

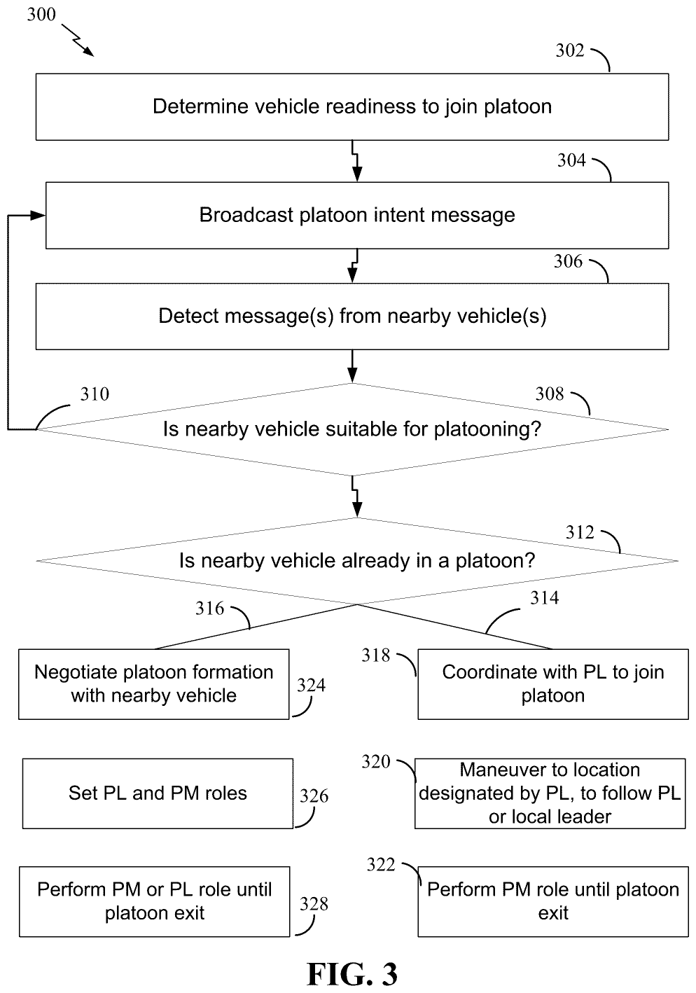

Referring now to FIG. 3, an example process 300 is shown for an initial phase, which may be utilized to enable a given vehicle (sometimes referred to herein as a “host vehicle”) to form or join a platoon. The host vehicle may be equipped with an integrated, OEM communication and control system (including software to cause performance of the steps of process 300), or may be equipped with an aftermarket module as further described below in the “Hardware” section. Additionally, the host vehicle may comprise any level of automated driving—the following description will note where alternatives or differences in the steps could be utilized depending on vehicle capabilities.

At step 300, the host vehicle may first confirm that its status is amenable to platoon joining. For example, software logic may be utilized to limit platoon formation to only situations in which the host vehicle is located on a particular roadway type (e.g., determination based on location data that the host vehicle is on an interstate highway); is traveling at a given speed; has a fuel/energy level sufficient for platooning for a reasonable duration (e.g., at least enough fuel/charge for 5 minutes, 10 minutes, 15 minutes, 30 minutes, 45 minutes, 1 hour, etc. of platooning, or for 5 miles, 10 miles, 15 miles, 30 miles, 45 miles, 60 miles, etc. of platooning); has suitable transmission/reception quality; has a suitable driver status; etc. In some examples, the host vehicle may make this determination after a driver/user has requested platoon formation, or may periodically check to determine whether such conditions exist, or may check on such conditions only during certain drive modes (e.g., once reaching a threshold speed, when adaptive cruise control or similar features are enabled, etc.). When it is confirmed that the vehicle's status is amenable to platoon joining, the process 300 may then entail broadcasting a platoon intent message or a similar invitation or inquiry to other vehicles that may also be available to platoon.

Referring still to FIG. 3, following the determination of vehicle readiness as described above, example process 300 may continue with steps that enable the host vehicle to either form a new platoon or join an existing platoon. The host vehicle may, for example, utilize integrated communication systems compliant with Dedicated Short-Range Communication (DSRC) protocols or similar vehicle-to-vehicle (V2V) communication standards. At step 304, the host vehicle may broadcast a platoon intent message, or similar inquiry or invitation, to other vehicles nearby. For example, such a message may be transmitted as part of a Basic Safety Messages (BSM) protocol, with a range consistent with DSRC broadcasts or other localized transmissions. The messages may include certain preliminary details, such as the host vehicle's identification, current position, speed, heading, and intended destination. In certain embodiments, the message may further include data indicative of the host vehicle's readiness for platooning, such as fuel or battery levels, drive mode (e.g., adaptive cruise control enabled), and an indication of its role preferences (e.g., whether it can serve as a Platoon Leader (PL) or Platoon Member (PM)).

In yet further embodiments, such messages may be anonymized or otherwise stripped of private or sensitive information, or encrypted in a manner that prevents unauthorized use. For example, the platoon invitation messages may be encrypted and, upon receipt, other vehicles would need to rely on a cellular or other Internet connection to a remote server to decrypt the message and verify the sender's attributes. Other alternative examples may entail sending only partial information, rather than full data regarding the host vehicle's status and attributes relevant to platooning—for example rather than broadcasting a destination, a platoon message may instead broadcast only an indication of how many miles the vehicle will travel on the current roadway; and, rather than indicating fuel/charge level or driving mode, the vehicle may instead send a code indicative of suitable resources to platoon.

The host vehicle may periodically transmit the platoon intent message until another vehicle responds with a message relevant to platoon formation or joining. While the host vehicle broadcasts its intent/invitation messages, it may continue to travel under ordinary behavior, such as changing lanes, speed, etc. per the driver's actions or automation.

Referring still to FIG. 3, at step 306, the host vehicle may monitor for incoming messages from nearby vehicles to evaluate potential opportunities for platoon formation or joining. In implementations in which dynamic platooning requests are transmitted via frequency bands or communication protocols that may also entail messages for other (non-platooning) purposes, step 306 may also entail reading additional messages and filtering or sorting them by purpose. Messages sent by nearby vehicles that may be relevant to platooning can be determined by content, packet protocol settings, and/or format of the messages.

Such messages may include platoon intent messages or similar broadcasts from other vehicles that are also available for platooning, as well as platoon status messages from active platoons. For example, other vehicles that are not currently in a platoon may periodically transmit their own intent messages, similar to those described above with respect to the host vehicle at step 304. Meanwhile, vehicles already participating in an existing platoon may transmit platoon status messages or similar notifications indicating their current configuration, such as speed, heading, destination, and available positions for new vehicles to join.

At step 308, the host vehicle may determine whether a nearby vehicle is suitable for platooning based on the messages received at step 306. Suitability may be assessed, for example, based on compatibility of destination data, alignment of speed, and proximity as described herein. The host vehicle may analyze all incoming messages to identify, rank, and/or categorize relevant opportunities. For example, the host vehicle's communication module may analyze detected “platoon-relevant” messages based on certain criteria, such as:
Message Source Proximity: Prioritizing messages from vehicles or platoons within a defined range (e.g., 100 meters, 200 meters, 300 meters, etc.).
Destination or Travel-Path Compatibility: Evaluating whether the broadcasting vehicle or platoon has a shared or closely aligned route, as determined by destination data or anticipated travel distance on the current roadway, or current roadway plus one or more subsequent roadways (e.g., based on use of bypass freeways or local/downtown freeways).
Speed Alignment: Assessing vehicles or platoons by speed, to find those that may be traveling at a speed within a predefined tolerance (e.g., ±5%, ±10%, etc.) of the host vehicle's current speed or within a predefined range of acceptable platooning speed.
Communication Quality: Ensuring that the received messages meet a minimum threshold for reliability, such as signal strength, data error rate, or message latency.
Vehicle Ratings or Scores: Assessing information concerning the driving behavior of the vehicle or platoon, past safety information, or user ratings. For example, each platoon or vehicle may be programmed to automatically generate a composite score or multiple individual values pertaining to its degree of lane changing, vehicle separation, frequency of braking, etc. for its current drive, and may include such information in its status or intent messages. In other examples, each vehicle may be assigned a continually-updating “rating” (similar as a ride-share driver's rating) based on other users' experiences, which can be included in its broadcasts. Thus, the host care may implement preferences such as only joining or forming a platoon with vehicles having given score, drive characteristics, or ratings.

In some embodiments, the host vehicle may assign weights or priorities to these and other criteria, and perform a multi-factor evaluation to rule-out opportunities that do not meet desired criteria and/or to rank and identify the most suitable opportunity for platoon formation or joining.

If no suitable vehicle is detected, then process 300 may ignore or decline messages from the nearby vehicle(s) or platoon(s) at step 310 and instead resume periodically rebroadcasting its platoon intent message (as described in step 302) at predefined intervals, such as every 5 seconds, 10 seconds, 30 seconds, or another duration. Alternatively, the host vehicle may dynamically adjust the rebroadcast interval based on roadway density or other environmental factors.

If a suitable opportunity is identified, the host vehicle may then determine at step 312 whether the nearby vehicle that transmitted the message detected at step 306 is already part of an existing platoon. (Alternatively, steps 312 and 308 may be performed in opposite order and/or be part of the same step). This determination may be made based on the content of the received message. For example, a vehicle that is not in a platoon may be merely broadcasting an intent message similar to that described at step 304. A vehicle that is part of an existing platoon may instead broadcast a platoon status message, which may include information such as the Platoon Leader (PL) identification, current platoon configuration, available positions, and instructions for joining. In further embodiments, a vehicle that is interested in leaving its current platoon soon may send a message similar to an intent message.

If a determination 316 is made that the identified nearby vehicle is not part of an existing platoon, the process 300 may proceed to step 324, where the host vehicle engages in negotiation to form a new platoon. Specifically, the host vehicle may transmit a platoon join request (PJRQ) or similar message to the identified vehicle. Such negotiation may include an exchange of relevant data, such as speed, heading, destination, common travel paths and/or route segments, platoon structure and drive characteristic preferences, and fuel/charge levels, to confirm compatibility for platooning (if not already communicated). The driver of the host vehicle may also be shown a prompt or other notification in a dash or instrument cluster of the suitable platooning opportunity for confirmation that the driver desires to enter into a new platoon. Further details of various examples for negotiating platoon formation are described below. For example, the vehicles may exchange settings and preferences for driving behavior such as criteria for lane changing, acceptable inter-vehicle distances to be kept, acceptable speed or speed ranges for the platoon, driver involvement requirements, sensor capabilities, whether the platoon should admit additional members or not, etc.

Upon successful negotiation, at step 326, the vehicles may establish their respective roles within the platoon. For example, one vehicle may assume the role of Platoon Leader (PL) while the other assumes the role of Platoon Member (PM). Role assignment may be based on predefined criteria, such as relative position (i.e., the vehicle that is already ahead of the other vehicle becomes the leader by default); relative speed (the faster vehicle becomes the leader); vehicle size or profile (e.g., a large truck may assume the lead role to provide more fuel economy to a smaller car, or vice versa); sensing capabilities (whether or not in context of current conditions) such as a vehicle that merely has optical sensors becoming a PM at night if the other vehicle also utilizes LIDAR or ultrasonic sensing; driving safety record; automation capabilities (e.g., a vehicle that merely has adaptive cruise control may need to be a leader if the other vehicle has a higher level of autonomy); or resource availability. In further embodiments, a driver may input preferences for always being the PL or PM.

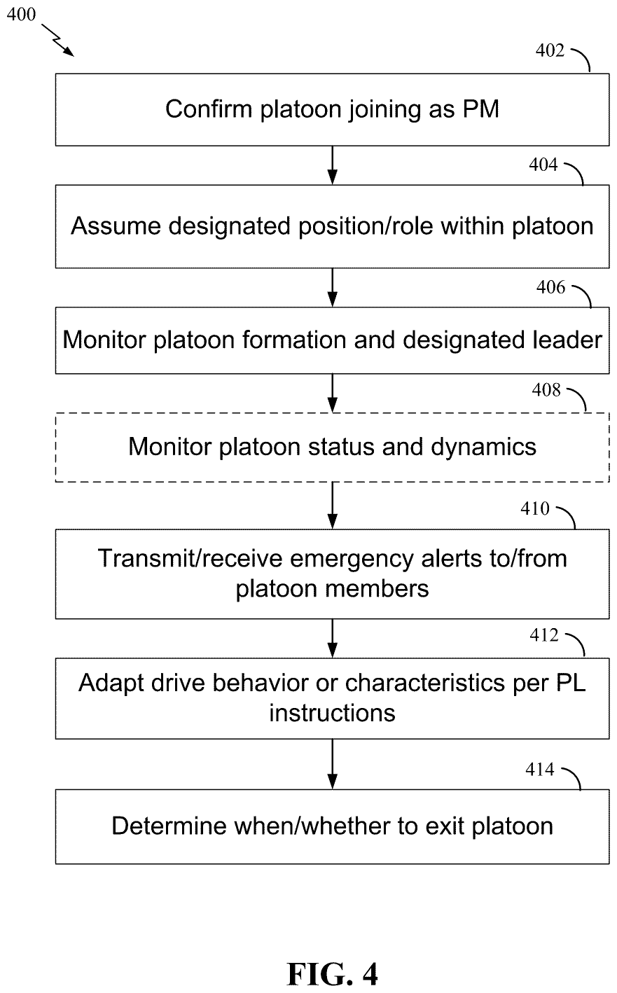

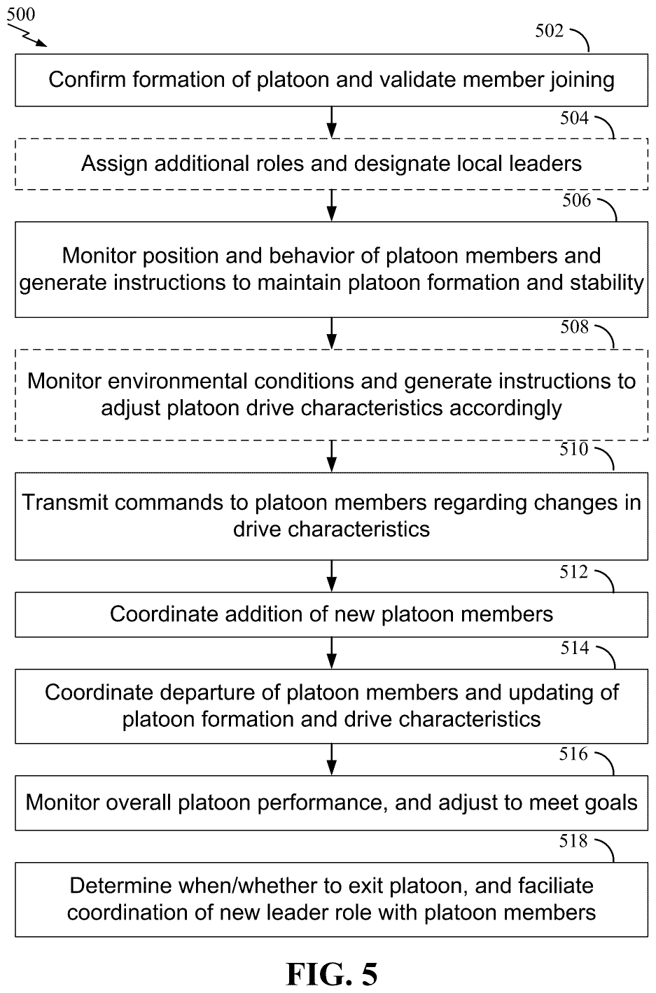

Once roles are determined and a platoon is successfully negotiated between two vehicles, the vehicles may each then enter into a state of performing their respective roles as PM or PL, as described below with respect to FIGS. 4 and 5, until the vehicle determines that it should exit the platoon. A determination of platoon exit can be made independently by any member of the platoon for itself. For example, a PM may determine it should exit the platoon because its travel-path will require taken a highway exit that other platoon members will not take, because the driver wants to exit the platoon, because the platoon's driving criteria no longer meet requirements (e.g., poor weather conditions, erratic driving behavior, etc.), or because the PL sends an indication that it will end the platoon.

If a determination is made at step 314 that the identified vehicle is already part of an existing platoon, the process proceeds to step 318, where the host vehicle may coordinate with the Platoon Leader (PL) of the identified platoon to negotiate joining. In some embodiments, this may involve transmitting a platoon join request (PJRQ) or similar message directly to the PL of the nearby platoon. The PL may evaluate the host vehicle's compatibility with the platoon, and determine whether to admit the host vehicle. If the request is accepted, the PL may provide the host vehicle with joining instructions, such as a designated position within the platoon and the identity of a local leader (e.g., the last vehicle in the platoon) for alignment purposes. The PL may also provide settings and/or preferences of the platoon, such as inter-vehicle distance, max/min speeds, etc.

Upon receiving joining instructions, the host vehicle may execute a platoon formation maneuver at step 320. This may include actions such as adjusting speed to match the platoon, conforming to required inter-vehicle gap distance, and/or changing lanes to align with the designated position. In some examples, the host vehicle may autonomously perform the formation maneuver using onboard control systems. In other examples, the maneuver may be performed with driver assistance, depending on the level of vehicle automation. In vehicles that are not fully autonomous, a notification may be displayed to the driver indicating which lane to move into. Once the host vehicle has successfully joined the platoon, it may confirm its position to the Platoon Leader by transmitting a platoon complete message or similar confirmation.

At step 322, the host vehicle assumes the role of a Platoon Member (PM) and begins performing PM functions, such as maintaining synchronized speed, heading, and inter-vehicle distance relative to the PL or local leader. In some embodiments, the host vehicle may exit the platoon based on certain conditions, such as reaching its destination, encountering route deviations, or detecting changes in driver input. Such conditions may trigger a platoon exit maneuver at step 320.

In alternatives of the foregoing process 300, additional functionalities may be realized. For example, where a new host vehicle or existing PM is unable to transmit and/or receive messages directly from the PL (whether due to being out of range, inconsistent packet delivery, latency, etc.), a message relay function may be provided by other PMs (e.g., including local leaders, as described below) in which messages from the new host vehicle or the PM are received by another PM and relayed to the PL. In yet further embodiments, dynamic role reassignment may occur after a platoon has been formed. For example, if weather conditions render the environment sensors of the PL less optimal than the sensors of the PM, the vehicles may re-negotiate roles and confirm the role reassignment. Or, the vehicles may predefine a length of time that each will serve as PL/PM so that each vehicle can experience a given (e.g., equal) fuel economy benefit from the platooning, and initiate a role switch periodically or at a given time/geography. In such cases, a suitable instruction for lane changes and other maneuvering would be provided to the PL and PM so that they could switch positions (with the PM becoming the forward vehicle), which can then be translated into movement instructions by the vehicles' onboard systems according to their level of autonomy (e.g., if the PM that will become PL has only adaptive cruise control, but the PL is fully autonomous, then the PL may undertake lane changing and maneuvering to allow the PM to move ahead; or if one of the vehicles is not fully autonomous, a driver message or alert may be displayed instructing the driver to maneuver to become the new PL/PM as applicable).

In further embodiments, additional information may be calculated onboard each vehicle concerning the predicted impact of platooning. For example, a user interface or display may indicate to a driver what the predicted fuel/charge saving may be of joining a given platoon, the predicted carbon emissions savings, etc. Similarly, navigation software may provide options for driving route outcomes depending on whether a platoon can be found or not. In this sense, each vehicle that intends to or is available to platoon may opt in to broadcasting its location and heading via a cellular connection to a remote server that is common to all vehicles using the platooning platform, so that, even if out of range of local transmission, vehicles that want to platoon can be made aware of opportunities in their general vicinity, such as through a dashboard application or third party device (e.g., app on a mobile device or aftermarket unit).

Through such an interaction, significant advantages of certain systems and methods described herein are realized: a vehicle can have environment sensors/capabilities/autonomy different from other vehicles, and still join a platoon with those vehicles on the fly; and, the group of vehicles need not be commonly controlled, owned, manufactured, deployed, or have prearranged coordination, etc. The vehicles that will join a platoon can decide when and whether to join, as well as whether the conditions and characteristics of a given platoon are likely to meet, and/or are actually meeting, preferences or requirements of each vehicle's operator. In this sense, each vehicle can leave or join at will, and roles can be reassigned on the fly.

Referring now to FIG. 4, an example process 400 is shown, which illustrates potential actions that may be taken by a platoon member (PM) once it has successfully joined a platoon. The process 400 describes activities that the PM may undertake to maintain its role within the platoon, including confirming its position, monitoring the status of other platoon members, responding to emergency or braking events, and determining whether it should continue within or exit the platoon. Some or all of these steps may be performed or omitted, or rearranged and/or modified, in any given implementation. Furthermore, a driver may always be given the option to override any of the maneuvers and driving settings (e.g., speed, gap distance) described below. Thus, the PM may be equipped with integrated hardware and software that can interact with a user interface, or may have an aftermarket system with a user interface, to perform these activities, and the steps described herein may vary based on the PM's level of automation and sensor capabilities.

At step 402, the PM may confirm its successful joining of the platoon by transmitting a confirmation message (such as a Platoon Complete (PC) message) to the Platoon Leader (PL). This confirmation may include the PM's current position, heading, and speed, as well as any other relevant attributes such as its communication status or sensor functionality. The PL may respond with an acknowledgment and provide the PM with further instructions, such as its designated position within the platoon and the identity of a local leader, if applicable.

Following confirmation, at step 404, the PM may determine its position within the platoon and take actions to maintain that position. In particular, the PM may utilize Basic Safety Messages (BSMs) to both determine and broadcast its relative location within the platoon. For example, the PM may periodically receive BSMs from the PL and other platoon members, including data fields specifying their current position, speed, heading, acceleration, and braking status. By comparing these data fields to its own position and trajectory, the PM may calculate its relative position within the platoon. For instance, the PM may compute its distance to the PL or the local leader by analyzing the received positional coordinates and time-stamping information. Further information concerning the use of BSMs to determine relative position of platoon members is described below in the Examples section. The PM may also use path prediction data included in certain BSMs to anticipate the movements of nearby vehicles and adjust its own behavior accordingly. For example, if a local leader broadcasts a lane change maneuver via BSM, the PM can predict the new trajectory and modify its speed or heading to maintain alignment.

In addition to processing incoming BSMs, the PM may also periodically transmit its own BSMs to update other platoon members on its current status. These messages may include the PM's latitude, longitude, elevation, heading, speed, level of autonomy or driver assistance in use, and other relevant data, allowing other members to refine their understanding of the platoon structure.

At step 406, the PM may monitor the platoon structure and its assigned local leader (if one is designated). In some examples, the local leader may be the vehicle immediately ahead of the PM, which simplifies position tracking and communication. The PM may continuously monitor the local leader's speed, heading, and braking events using BSM data received at regular intervals. By processing this information, the PM can dynamically adjust its position and speed to maintain a consistent inter-vehicle gap.

At step 408, the PM may also optionally monitor the status and dynamics of the entire platoon, in addition to or instead of simply the PL. This includes receiving periodic updates from the PL or a local leader regarding platoon configuration, speed, route changes, and external conditions (e.g., traffic or weather alerts). Additionally, the PM may evaluate the status of nearby platoon members for deviations in speed, position, or heading that could indicate instability. For example, if a nearby vehicle begins to deviate from its designated position, the PM may use its own BSM broadcasts to alert the PL or local leader and adjust its behavior to preserve platoon integrity.

In further embodiments, the PM may also transmit and/or receive emergency or braking alerts at step 410. For example, if the PM detects an obstacle or performs a sudden braking maneuver, it may immediately broadcast an Emergency Alert (EA) or similar message to the PL and other platoon members. The PM may include additional information in such alerts, such as the nature of the detected emergency (e.g., obstacle type, severity) and recommended maneuvers (e.g., decelerate, change lanes). In some examples, the PM may also reduce its inter-vehicle gap preemptively if it detects a potential hazard ahead.

At step 412, the PM may adapt its behavior in response to instructions received from the PL. For example, the PL may broadcast commands to adjust the platoon's overall speed, change lanes, or reorganize member positions. These instructions are typically communicated through structured BSMs or similar messages containing both action directives and time stamps for synchronization. The PM may execute these commands autonomously using onboard control systems or with driver assistance. In some embodiments, the PM may also receive updated configuration data, such as inter-vehicle gap distances or lane alignment preferences, from the PL or local leader.

In further examples, the PM may receive an instruction to behave as a local leader for a designated other PM or group of PMs. In some embodiments, the local leader may then: relay BSM communications from the P1 to the PMs in its sub-group, ensuring that commands (e.g., speed adjustments or lane changes) are received accurately and promptly; monitor and assess status of the PMs in its sub-group, and send updates about the managed PMs back to the PL, such as position, speed, detected anomalies or non-compliance, unacceptable drive characteristics or behavior, etc.; maintain sub-group stability, such as tracking relative positions, speeds, inter-vehicle gaps, and emergency events within its assigned group, and ensuring the PMs in the sub-group adhere to the global PL's instructions; execute commands locally, such as implementing platoon-wide commands like emergency braking, stopping for a stop-sign/signal, or overall speed changes; managing local adaptations, such as adjusting inter-vehicle gaps or speeds to address local environmental or traffic conditions, road curvature, or obstacles detected by the local leader, its sub-group, the PL, or other PMs; enhance communication by serving as a relay for other PMs or other sub-groups; assisting in integrating new vehicles admitted by the PL by providing joining instructions for the sub-group and coordinating alignment within the sub-group; responding to local emergencies by coordinating braking or evasive maneuvers for the sub-group, including causing the sub-group to depart the platoon entirely as a new platoon (e.g., if the sub-group will not be able to navigate a roadway change, stop-light, emergency situation, etc.); and other localized management actions.

Furthermore, the PM may utilize its own onboard sensors to confirm whether the instructed driving behavior change is safe and/or appropriate. Thus, one advantage of the systems and methods herein is demonstrated: each PM can still make its own decisions regarding whether to follow the PL's instructions, and can rely on its driver and/or native sensing capabilities to independently determine whether the platoon activities should still be followed. For example, if a PL instructs a lane change, but the PM (which may be several car lengths behind) determines that there is a vehicle or other obstruction in the way of a lane change, the PM can ignore the instruction entirely or delay executing on the instruction until the PM independently determines it would be safe to perform the instructed driving behavior change. In other words, the instructions sent by the PL may merely be guidance that each PM independently evaluates. As another example, if the PL instructs the PM to move closer to a local leader by adjusting inter-vehicle gap, but the PM's onboard sensor and/or settings indicate that the PM is already close enough, the PM may ignore the PL instruction and/or respond with a confirmation that the PM is adhering to a safe distance.

At step 414, the PM may determine whether it should continue with the platoon or initiate a platoon exit. For example, the PM may evaluate whether its destination or route aligns with the platoon's travel path. If the PM determines that its exit is imminent (e.g., due to reaching a highway exit or diverging route), it may notify the PL and initiate a safe exit maneuver at step 414. Such maneuvers may include changing lanes to separate from the platoon, decelerating, or returning to non-platoon driving behavior. In some embodiments, the PM may also send a Platoon Exit Notification (PEN) to the PL and other platoon members to confirm its departure. Alternatively, at any point in time the PM and/or its driver may decide to exit the platoon for any reason (e.g., the driver elects to leave the platoon, initiates a turn signal and slows down to exit a highway or other behavior indicative of leaving the platoon, the safety or other criteria of the platoon no longer meet preferences, etc.), in which case a platoon exit message may be sent to the PL.

In additional examples, the PM may support dynamic role reassignment within the platoon. For instance, if the current PL exits the platoon (or notifies of an impending exit), the PM may assume leadership responsibilities based on pre-established criteria such as proximity to the front of the platoon or sensor capabilities. Alternatively, the PM may negotiate with other platoon members to assign a new PL and reconfigure the platoon accordingly.

In yet further embodiments, the PM may participate in message relaying to enhance communication within the platoon. For example, if another PM is out of range of the PL, the PM may act as an intermediary, forwarding messages between the two. This functionality ensures consistent communication and coordination within larger platoons or in areas with limited signal range.

The process 400, as illustrated in FIG. 4, thus provides a framework for the activities and responsibilities of a platoon member after joining a platoon. By maintaining communication, monitoring platoon dynamics, and responding to emergency situations or PL instructions, the PM ensures the stability and efficiency of the platoon. This process is adaptable to various levels of vehicle automation and is scalable for implementation in platoons of varying sizes and configurations.

Referring now to FIG. 5, an example process 500 is shown for a Platoon Leader (PL) to manage and coordinate a platoon after its formation. The process 500 describes activities that the PL may undertake to ensure the stability, efficiency, and safety of the platoon, including assigning roles to new members, maintaining platoon alignment, monitoring member positions, issuing commands, and coordinating exits or role changes. The PL may be equipped with integrated communication and control systems that allow for autonomous or semi-autonomous execution of these activities, with variations depending on the PL's hardware and software capabilities.

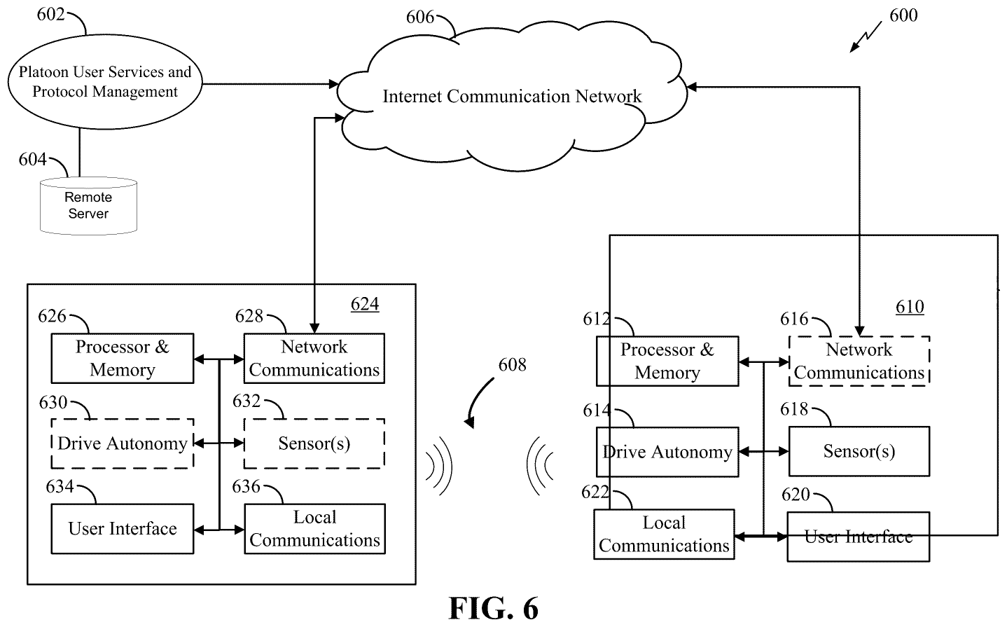

At step 502, the PL confirms the formation of the platoon and validates the successful joining of all current members. This may be performed by onboard, integrated hardware of the PL (such as described in FIG. 6, below) or an aftermarket or third party device, and may be done automatically or only after driver acceptance. For example, when a new vehicle joins the platoon, the PL may receive a Platoon Complete (PC) message or similar confirmation from the new member. This message may include details such as the new member's identification, position, heading, and speed. In some embodiments, this information may be displayed to a driver of the PL in a variety of forms, such as categorical designators (e.g, number of PMs, whether any PMs are out of specification in terms of speed or alignment, duration that each PM is expected to be part of the platoon, etc.) or on a PM by PM basis, such as in a driver display or other user interface of the vehicle or device. The PL may respond with an acknowledgment message, and update its internal platoon member list to reflect the addition. Again, the PL may undertake some or all of these steps automatically, such as when in an autonomous driving mode, or with varying levels of driver involvement ranging from simply adjusting a setting that platooning is acceptable, to accepting formation of a given platoon, to accepting given platoon members.

Following confirmation of membership, at step 504, the PL may optionally assign more specific roles for the platoon members, such as designating local leaders, and which members follow the local leaders within the platoon. For instance, the PL may divide the platoon into smaller sub-groups and assign a local leader to each sub-group, typically selecting the vehicle at the front of each group to be the local leader (though, in other embodiments, local leaders may be designated based on destination or duration of time following the current route path on the current roadway, or other similar metrics). Local leaders may facilitate communication and coordination within their respective sub-groups, reducing the overall communication burden on the PL. In some embodiments, the PL may dynamically adjust these assignments based on the real-time behavior or status of platoon members, such as relative position, speed, or communication reliability, or in context of weather conditions or driving safety indicators (e.g., a large SUV may be designated as a local leader in poor weather conditions, whereas a smaller vehicle with more sophisticated sensing capabilities may be designated as a local leader in good weather conditions, or irrespective of vehicle capabilities a local leader may be selected based on driver rating/safety record maintained by the software platform that deploys the platooning algorithms).

At step 506, the PL maintains overall platoon alignment by monitoring the position and behavior of each platoon member. For example, the PL may periodically receive Basic Safety Messages (BSMs) from each member, providing data such as position (latitude, longitude, elevation), speed, heading, acceleration, and braking status. Using this data, the PL may identify deviations in inter-vehicle gaps, lane alignment, or speed uniformity. In response, the PL may issue commands to individual members or the entire platoon to restore proper alignment.

At step 508, the PL may monitor the external environment and traffic conditions to ensure safe and efficient operation of the platoon. This may involve collecting data from onboard sensors, such as radar, LIDAR, or cameras, as well as receiving information from infrastructure or external sources, such as traffic management systems or weather alerts. In other embodiments, the PL may simply be operating via a level 1 or level 2 autonomy basis, in which case the driver may be required to remain alert with hands on wheel, monitoring the environment. Based on the detected environmental data and/or the driver's adjustments of speed and/or lane, the PL may adjust the platoon's speed, lane position, or formation to adapt to changing conditions.

At step 510, the PL issues commands to the platoon to coordinate its movement and actions. These commands may include, but are not limited to:
Speed Adjustments: Increasing or decreasing the overall speed of the platoon to match traffic flow or respond to environmental conditions.
Lane Changes: Directing the platoon to move to a different lane, such as when approaching a highway exit, passing a slow moving vehicle, drafting behind a larger vehicle, navigating road construction or road narrowing features of a roadway that may impact the position or number of lanes, or avoiding an obstacle.
Formation Adjustments: Modifying the platoon's structure, such as increasing inter-vehicle gaps in poor weather or transitioning to a single-lane configuration in high-density traffic.

Commands may be broadcast using structured BSMs or similar messages, including action directives, target positions, and time stamps to ensure synchronized execution by all members. In some embodiments, the commands may comprise specific directives that can be actioned by autonomous vehicle driving systems (e.g., change steering heading at a given time by a given number of degrees until the vehicle enters an adjacent lane based on vehicle optical sensing of lane markers, followed by a corresponding shift in steering in the opposite direction to align the vehicle within the lane, then engage lane keeping), or may instead simply provide a goal (e.g., move one lane left). In the latter case, the PM receiving such an instruction may include a processor running software instructions that translate the received message into appropriate actions or commands tailored to the vehicle's autonomous capabilities, current autonomy state, and locally-sensed environment information. For example, the PM can simply indicate to the driver to navigate to a different lane via a dashboard display, then reengage adaptive cruise control. In another example, the PM can translate the PL's instruction into actions to be taken by an autonomous driving system, which can engage its own native sensors to determine how and when to execute the lane change. In some cases, the PM may simply determine that it cannot or should not execute the PL's instruction due to its own safety and monitoring information, and can respond to the PL with a message indicating the same.

At step 512, the PL manages the addition of new members to the platoon by processing messages sent by additional nearby vehicles. For example, when a vehicle requests to join the platoon, the PL evaluates the request based on compatibility criteria such as destination alignment, speed, and position. If the request is accepted, the PL may broadcast a message of admission to the new member and/or the existing members, and may assign the new member a position within the platoon and broadcast platoon joining instructions for aligning with the designated local leader or global leader. The PL also updates its internal records and may broadcast an updated platoon status message to all members. In this sense, each member of the platoon may be given a unique identification number (or may have an identification number or messaging address) so that messages can be broadcast via

At step 514, the PL coordinates the departure of members for which it is determined they should exit the platoon. For instance, when a member notifies the PL of its intent to leave (e.g., via a Platoon Exit Notification (PEN)), the PL acknowledges the notification and may provide instructions for a safe exit maneuver, or guidelines for how to exit (e.g., if the platoon is about to shift into another lane, the exiting vehicle should not attempt to leave the platoon by that lane). This may also include instructions to be sent to other PMs, such as reducing the platoon's speed or adjusting its lane position to facilitate the departing member's separation. If the departing member is a local leader, the PL reassigns the role to another member to maintain platoon structure.

In other embodiments, a departing PM may not provide a notification of platoon exit, such as if the driver abruptly turns off or disengages the hardware that manages platoon communications, or simply steers the vehicle away from formation (such as to exit a roadway), and a PL may instead deem a PM to have departed the platoon by monitoring its relative position, heading, and speed, and responses (or lack of responses) to platoon messaging protocols. For example, if a PM changes lanes and increases speed such that it is not following its local leader, the BSMs broadcast by the PM will indicate driving attributes that meaningfully differ from the platoon's coordinated behavior. In other words, such a behavior is not simply independent adjustment of driving calculated by the PM to follow platoon instructions, but rather is indicative of the PM's intent to leave the platoon. In other examples, where a PM consistently is not following the platoon's speed, heading, lane shifts, inter-vehicle gap, or other drive characteristics, the PL may send a notification to the PM that it should exit the platoon as well as notifications to other PMs to reform the platoon without the PM.

In yet further embodiments, where a PM exhibits a threshold number of unacceptable drive actions, behavior, or characteristics (a given number of sudden braking maneuvers, lane drifting, ignored instructions, repeatedly leaving/joining the platoon, etc.), the PL may determine that the PM should leave the platoon and will broadcast a platoon exit instruction to the PM, update its memory regarding the platoon structure/status, update roles and positions of platoon members, and send new drive instructions to the other PMs to cause them to align in a desired way without the existing PM.

At step 516, the PL may continuously monitor the overall stability, safety, and efficiency of the platoon. This may include, for example, tracking metrics such as predicted fuel or energy savings, inter-vehicle communication reliability, and member behavior (e.g., frequency of braking, speed variability). The PL may use this data to make adjustments to the platoon's configuration or provide feedback to individual members. For example, software running on a processor of the PL may periodically assess the PM(s) in the platoon and determine if a different sequence or arrangement of vehicles would be more likely to realize better fuel/charge efficiency. For example, the PL may make this determination based on vehicle size determined from make/model information or broadcast by each PM as part of a BSM; or based on vehicle driving behavior—so that vehicles more prone to inconsistent speed or frequent braking are at or near the rear of the platoon. In alternative embodiments, each PM's BSM messages may include current fuel efficiency, so that the PL can base formation change decisions on actual reported fuel economy improvements of the platoon in real time. Similarly, the software running on the PL may provide for a balancing of fuel economy benefits among platoon members so that all members receive as close to ‘equal’ benefit as possible, or to maximize overall fuel/charge economy of the platoon as a whole, or to allocate benefits to vehicles traveling longer distances or with smaller fuel/charge capacity. Such evaluation may also be made whenever a new PM enters the platoon or exits the platoon, or when anew PM requests to join a platoon. Similarly, the PL may monitor local weather conditions provided by third party services and/or detected by onboard sensors of the PL to determine if inter-vehicle gaps should be increased or speed decreased. In some embodiments, the PL may share efficiency metrics or other relevant information with platoon members via periodic status updates.

At step 518, the PL may dynamically determine when and whether to exit the platoon, just as any other platoon member can do. In other words, a given vehicle's role as platoon leader is not necessarily a condition to continued operation of the platoon by the other platoon members. A PL may determine that it should exit a platoon for a variety of reasons, such as that it needs to navigate in a new direction not shared by the other platoon members, it wishes to operate at a speed, inter-vehicle gap, or other drive characteristic that was not agreed upon or desired by the other platoon members when the platoon was formed, the driver of the PL vehicle simple wishes to no longer be the PL or be in the platoon, or other similar reasons. Upon a determination being made that the PL will exit the platoon or no longer serve as PL, the PL can trigger a role negotiation to occur among the remaining platoon members regarding which should optimally be selected as the new PL. This can occur dynamically while the vehicles continue traveling, such that as soon as the PL actually executes its departure from the platoon, the new PL has been selected and can take on the PL role in terms of its physical position relative to the other members as well as the behavior it undertakes (e.g., per the other steps of FIG. 5).

In additional embodiments, the PL may support dynamic role reassignment within the platoon. For example, if the PL is nearing its destination or experiences reduced sensor functionality (e.g., due to adverse weather), it may negotiate with another platoon member to transfer leadership responsibilities. The PL may also predefine periodic role changes to distribute the leadership burden and fuel efficiency benefits among all members.

In yet further embodiments, the PL may implement message relaying to enhance communication within larger platoons. For instance, if a platoon member is out of direct communication range, the PL may direct a nearby member to act as a relay, ensuring that all commands and status updates reach the intended recipients.

The process 500, as illustrated in FIG. 5, provides a robust framework for the actions and responsibilities of a Platoon Leader after the formation of a platoon. By monitoring member behavior, issuing commands, adapting to environmental conditions, and coordinating entries and exits, the PL ensures the stability, efficiency, and safety of the platoon. This process is adaptable to various levels of automation and is scalable for platoons of differing sizes and configurations.

Accordingly, it can be seen that the protocols, approaches, architectures, systems, and methods described in FIGS. 3-5 provide several advantages that significantly improve vehicle platooning technology. By way of example, and without limitation, the inventors have determined the following as meaningful improvements on platooning technology:

One improvement is the establishment of reliable communication between platoon members using direct communication (without reliance on infrastructure like roadside units or cellular towers) via local transmission/reception of communications, such as via Dedicated Short Range Communication (DSRC) and Basic Safety Messages (BSMs). DSRC ensures low-latency, high-reliability data exchange, while BSMs provide real-time transmission of critical information, such as vehicle position, speed, heading, and braking events. Local communication capabilities can enable precise tracking, synchronized movements, and rapid emergency alert dissemination among platoon members, enhancing both safety and efficiency compared to prior systems. For example, where vehicles are equipped with local communication transceivers (such as DSRC modules or other transceivers broadcasting robust and stable communications via a dedicated frequency band and packet protocol/syntax) of a compatible nature.

Another improvement is the capability to implement dynamic, ad hoc, on-the-fly, and scalable management of platoons. By incorporating a hierarchical structure with dynamically-designated Platoon Leaders (PLs) and Local Leaders, systems and methods of the present disclosure can distribute communication and coordination tasks across members, reducing the computational burden on individual vehicles. This hierarchical organization, coupled with dynamic role negotiation and reassignment, ensures that even large platoons remain stable and responsive to changing conditions.

The described systems and methods also enhance safety through continuous real-time monitoring of platoon members. Vehicles transmit BSM data, allowing the participating platoon members to identify deviations in position, speed, or inter-vehicle gaps in a consistent, reliable manner (e.g., without relying on idiosyncrasies of each vehicle's sensing capabilities and operational state of its sensors, which can require periodic re-calibration). In response, the Platoon Leader can issue corrective commands to maintain alignment and cohesion. Additionally, emergency alert systems ensure that critical events, such as sudden braking or obstacles, are promptly communicated to all members, enabling rapid responses that mitigate potential collisions.

A significant efficiency improvement is achieved through optimized energy use. The systems and methods can maintain aerodynamically efficient formations that achieve a variety of goals, by dynamically calculating and adjusting inter-vehicle gaps and coordinating speed across members. These measures reduce drag and improve fuel or energy savings, benefiting all vehicles in the platoon. Furthermore, the systems and methods can adapt to environmental conditions, such as adverse weather, by adjusting gaps and speed to balance safety and efficiency.

Unlike many prior systems, the embodiments described herein minimize infrastructure dependencies, relying instead on onboard sensors, GPS, and DSRC modules. This design eliminates the need for specialized external infrastructure, such as lane magnets or centralized hubs, significantly reducing deployment costs. The system's compatibility with existing hardware also simplifies retrofitting older vehicles with aftermarket modules, broadening the potential user base.

The adaptability to varying levels of automation is another important improvement. The systems and methods herein can seamlessly integrate vehicles with different automation capabilities, from manual vehicles with basic driver-assistance features to fully autonomous systems. Instructions can be tailored to, or independently interpreted by, each platoon member based on each vehicle's level of automation, to ensure compatibility and safety, allowing mixed-automation platoons to operate effectively. Likewise, by relying on communication transmissions, systems and methods of the present disclosure can be sensor-agnostic, and allow for a highly heterogeneous mixture of car types, makes, models, capabilities, and functionalities. Because the PL need not directly control movement of the vehicles' driving systems, nor do the PMs' driving systems need to be pre-programmed to platoon, each PM can still independently operate according to its native driving assistance/autonomy systems based on its own native sensors (whatever they may be).

Dynamic role assignment and reassignment are another improvement, which enhance the flexibility of platooning. Roles such as Platoon Leader or Platoon Member can be assigned or adjusted based on factors such as fuel efficiency, sensor capabilities, or vehicle speed. This feature ensures that platoons can respond dynamically to changes in member conditions, such as a leader nearing its destination or experiencing reduced sensor performance.

The systems and methods described herein can also support improved traffic flow and congestion management. By synchronizing acceleration, deceleration, and lane-change commands across all platoon members, the systems and methods herein may help reduce the stop-and-go patterns that typically cause traffic waves. Efficient merging and lane-changing algorithms further minimize disruptions to other road users, improving overall traffic dynamics.

The system's advanced environmental adaptation capabilities further improve on prior approaches. By monitoring real-time data from onboard sensors and external sources, the system dynamically adjusts platoon behavior to suit current conditions. For example, it can modify inter-vehicle gaps in response to weather or traffic density, ensuring stable and efficient operation in diverse environments.

Additionally, the systems and methods herein provide far more cost-effective deployment options. By leveraging existing hardware such as DSRC communication modules and GPS, these systems and methods can eliminate the need for costly new infrastructure or specialized sensors. This makes the systems and methods more accessible for wide-scale adoption, including the retrofitting of older vehicles with aftermarket solutions. Collectively, these advantages make the described systems and methods a robust and versatile solution to the challenges of vehicle platooning.

### Hardware Configurations and Embodiments

Referring now to FIG. 6, a block diagram is shown illustrating a system architecture for implementing the methods described in FIGS. 3-5. The system comprises a first vehicle 610 and a second vehicle 624, both of which may perform some or all of the steps of the methods describe above—specifically, depending on how they locate one another and negotiate platoon formation, either one of them may operate as either a Platoon Leader (PL) or a Platoon Member (PM), depending on the conditions and configuration of their negotiated platoon. The vehicles communicate locally with one another via a dedicated local broadcast protocol 608 and, optionally, with a remote server 602 via an internet communication network 606.

Vehicle 610 includes an integrated system comprising hardware and software components for executing platooning algorithms. This system is capable of operating natively using the vehicle's existing original equipment manufacturer (OEM) hardware and software. Key components of vehicle 610 include a processor and memory module 612 for executing platooning logic and maintaining operational data, a drive autonomy module 614 for controlling vehicle movement at various levels of automation (ranging from Level 2 to Level 5 autonomy), a network communications module 616 for managing external communications, and a sensor array 618. The sensor array may include cameras, LIDAR, radar, or other sensing equipment for detecting surrounding vehicles and road conditions. The vehicle further includes a user interface 620, which may provide feedback to a driver or display status updates regarding platoon operations.

Vehicle 624, which may also serve as either the PL or PM, is similarly equipped for participating in the described platooning methods. In one implementation, vehicle 624 includes integrated hardware components analogous to those of vehicle 610. These components include a processor and memory module 626, a drive autonomy module 628, a network communications module 630, a sensor array 632, and a user interface 634. Alternatively, vehicle 624 may operate using an aftermarket device that executes the platooning algorithms independently of the vehicle's onboard systems. In such a configuration, the aftermarket device may communicate instructions to the driver via the user interface 634, prompting manual adjustments to vehicle controls as necessary. This approach enables vehicles without native platooning capabilities to participate in the platoon.

Vehicles 610 and 624 communicate locally through a dedicated local communications module 608 in vehicle 610 and a corresponding module 636 in vehicle 624. These modules may utilize communication protocols such as Dedicated Short Range Communication (DSRC) to enable low-latency, direct vehicle-to-vehicle (V2V) communication. This local communication facilitates the real-time exchange of Basic Safety Messages (BSMs), which include data such as position, speed, heading, acceleration, and braking status, as described in FIGS. 3-5.

In addition to direct V2V communication, both vehicles 610 and 624 may optionally connect to a remote server 602 via the internet communication network 606. The server 602 facilitates the management of platooning platform services, including vehicle registration, user identification, and verification credential management. The server also maintains information about vehicle ratings and safety scores, which may include aggregated data on driving behavior, historical performance, and user feedback. Additionally, the server 602 stores data on vehicle capabilities, such as automation level, sensor configurations, and energy efficiency metrics. This information may be used by the platooning platform to optimize platoon assignments, determine vehicle compatibility, and assign roles dynamically.

The remote server 602 also includes its own processor and memory for executing platform management algorithms and protocols. The server interfaces with vehicles 610 and 624 through the network 606, providing a centralized repository for managing platoon-related data while allowing decentralized execution of platooning methods by the vehicles themselves.

This system architecture enables seamless coordination between vehicles operating as PLs or PMs, whether they possess native or aftermarket platooning capabilities. The integration of local V2V communication with optional internet-based connectivity to the remote server ensures robust, scalable, and adaptable platoon management across diverse vehicle types and configurations.

The computing device 310 can be an integrated circuit (IC), a computing chip, or any suitable computing device that is able to compute large amounts of computations in parallel, as would be involved in deploying a deep neural network. In some examples, the computing device 310 can be a special purpose device to implement a neural network model, such as an ASIC that is developed to run a given neural network, or a GPU that is developed to efficiently run deep neural networks on training or sample sets in order to monitor neuron activity. Thus, the process 400 or 500 described in FIG. 4 or 5 can be tied to a special purpose device.

In the system 300, a computing device 310 can obtain or receive a dataset. In some examples, the dataset may support preprocessing methods such as cleaning, normalizing, scaling, and augmentation. During preprocessing, features from the dataset may be derived directly from raw data or extracted. The dataset can further include ground-truth labels. In some examples, the dataset may represent a diverse set of data and contain a balanced distribution of classes or case/control ratios to avoid bias and maintain model performance. For example, techniques such as sequence compaction and vector compaction may be applied to reduce the dimensionality of data, eliminate redundancy, and/or enhance storage, transmission, and processing efficiency. For example, in some experiments performed by the inventors, the dataset used was a Modified National Institute of Standards and Technology (MNIST) dataset 302 or a breast cancer dataset 304, or any other suitable dataset for benchmarking and validation. For example, the dataset can include an image, a medical record, X-ray data, magnetic resonance imaging (MRI) data, computed tomography (CT) data, or any other suitable data for classification. In other examples, the dataset can include one or more features extracted from input data. Also, in some examples, the dataset can include a training dataset to be used to optimize hardware for a neural network model. In some examples, the dataset can be produced by one or more sensors or devices (e.g., X-ray imaging machine, CT machine, MRI machine, a cell phone, or any other suitable devices). In some examples, the dataset can be directly applied to the neural network model. In other examples, one or more features can be extracted from the dataset and be applied to the neural network model. The computing device 310 can receive the dataset, which is stored in a database, via communication network 330 and a communications system 318 or an input 320 of the computing device 310.

In some embodiments, the processors of the vehicles can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. The processors may reflect general-purpose computational resources that control the entire vehicle, or may be dedicated processing resources for managing platooning functions. Similarly, the memory can include any suitable storage device or devices that can be used to store suitable data (e.g., software to run the platooning functions described above, user settings or predefined requirements and preferences for platoon drive characteristics, route mapping information, sensor data, and any other data or information used in performing the types of platooning described herein). The memory can include a non-transitory computer-readable medium including any suitable volatile memory, non-volatile memory, storage, or any suitable combination thereof. For example, memory 314 can include random access memory (RAM), read-only memory (ROM), electronically-erasable programmable read-only memory (EEPROM), one or more flash drives, one or more hard disks, one or more solid state drives, one or more optical drives, etc.

The network communications systems of the vehicles can include any suitable hardware, firmware, and/or software for communicating information over the Internet communication network 606 and/or any other suitable communication networks. For example, the communications systems can include one or more transceivers, one or more communication chips and/or chip sets, etc. In a more particular example, the communications system 318 can include hardware, firmware and/or software that can be used to establish a Wi-Fi connection, a Bluetooth connection, a cellular connection (e.g., a 3G network, a 4G network, a 5G network, etc., complying with any suitable standard, such as CDMA, GSM, LTE, LTE Advanced, NR, etc.), a satellite connection, combinations thereof, etc. In some embodiments, the communications system may be native to the OEM hardware of the vehicle, whereas in other embodiments the communications system may be specific to an aftermarket module or third party device.

The user interfaces of the vehicles may include visual and/or audio presentation to drivers. In some embodiments, the user interfaces may include any suitable display devices, such as a native dashboard display screen, a touchscreen, an infotainment screen, a mobile device, or simple directional and numeric light up indicators, etc. to display information to a driver at various points in performance of the methods described above, such as a report of platoon efficiency/fuel benefit, lane change indicators, new platoon requests, etc.

The sensor(s) of the vehicles may include vision sensors (e.g., optical 2D, stereo, depth, etc. cameras and detectors), infrared sensors, Radar systems, LiDAR systems (3D, solid state, etc.), ultrasonic systems, etc. The sensor(s) may also include GPS modules, IMU-type sensors (accelerometers, gyroscopes, magnetometers), odometry sensors, fuel/charge sensors, traction and ABS sensors, and other native sensors of the vehicle that detect its driving behavior (brake sensors, signaling light sensors, steering sensors, etc.). The sensor(s) may also include environmental sensors, such as rain sensors, temperature sensors, barometers, sunlight/ambient light sensors, acoustic sensors, and the like.

The local communications modules of the vehicles may include transceivers, antennas (omnidirectional, directional, or both), processors, memory, GNSS modules, DSRC onboard units, security and credential management systems, etc. For example, the local communications modules may allow for wireless vehicle-to-vehicle communication to vehicles within a given range, based on local broadcasting of digitized messages modulated onto a given frequency transmission, such as 5.9 GHz frequency band or similar. In some embodiments, the modules may be compliant with IEEE standards such as IEEE 802.11p.

### Examples and Experiments

Described below are details of various protocols developed by the inventors, as well as experimental setups, simulations, and validations of the disclosed systems and methodologies. It should be recognized that the following discussion is of particular examples—they are not limiting of the scope of this disclosure, but rather provide further details, algorithms, techniques, approaches, and concepts that can be used with the above-described systems and methods.

The inventors developed several platooning protocols that comprise novel algorithms, communication message types, and processes to be used by vehicles. In order to provide for simplicity in experiments, many of the processes were developed for use by nearly-autonomous or fully autonomous (e.g., Level 4 or Level 5) vehicles. However, as described above, the instructions and protocols contemplated herein are adaptable to use with vehicles of any level of autonomy.

The protocols developed in these experiments were designed to function effectively on roads which have more than 2-lanes or multiple-lane roads that can accommodate both left-side and right-side driving scenarios, even considering instances where heavy goods vehicles (HGVs) might not be allowed in the third lane. In the experiments described herein, the negotiation algorithms help vehicles to find other vehicles capable of platooning and assess platoon suitability, while the formation algorithms provide inputs required to generate the vehicle commands to join and maintain the platoon. These algorithms execute independently on each vehicle and process data from BSM messages transmitted among them. Each vehicle can transmit multiple BSMs per second that contain vehicle information such as speed, location, acceleration, heading, etc., as well as platoon negotiation messages, consisting of negotiation, sender id, and receiver id. When another vehicle receives a BSM containing a negotiation, the negotiation algorithms are developed in such a way that a negotiation is processed only if the receiver id matches the current vehicle id.

Further, the negotiation process in the inventors' experiments involves a combination of coordination and decision-making among the platoon agents. While the term “negotiation” is used, it's more accurately described as a coordination mechanism to determine the roles and positions within the platoon. When a vehicle seeks to join an existing platoon or form a new one, it broadcasts its intent and destination to nearby vehicles using BSMs. Vehicles which are nearby receive these messages and evaluate the negotiation requests based on predefined criteria such as vehicle speed, proximity, and destination. The negotiation resolver algorithm plays a role in analyzing these requests and making decisions. In these experiments, the inventors' protocols used five different types of negotiations. A brief description of each of them is provided below:
1. Platoon Join Request (PJRQ): Once a vehicle is ready to platoon, this negotiation is used to request another vehicle to form a platoon.
2. Platoon Accepted (PA): Upon receiving a PJRQ negotiation, a PA negotiation is sent to the requesting vehicle if the current vehicle accepts to form a platoon.
3. Platoon Join Ready (PJRY): Upon receiving a PA negotiation, a PJRY negotiation is sent back to the platoon accepted vehicle to acknowledge that the current vehicle is ready to join a platoon.
4. Platoon Leader Request (PLR): Upon receiving a PJRY negotiation, a PLR negotiation is sent back to the acknowledged vehicle by the current vehicle requesting to be a platoon leader.
5. Platoon Complete: After negotiating and forming a platoon, PM sends a PC negotiation to PL that the platoon formation is complete.

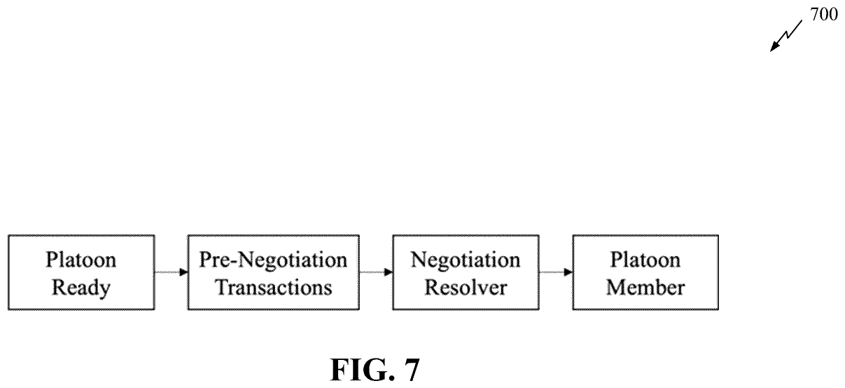

Using these negotiation messages and the negotiation algorithms, two or more vehicles can negotiate with each other to form a platoon initially. Once the platoon is formed, the PM will send a PC negotiation to the PL. Upon receiving this, PL makes itself available to accept future platoon requests. FIG. 7 depicts a flowchart 700 showing the relationship and/or sequence of performance of these algorithms.

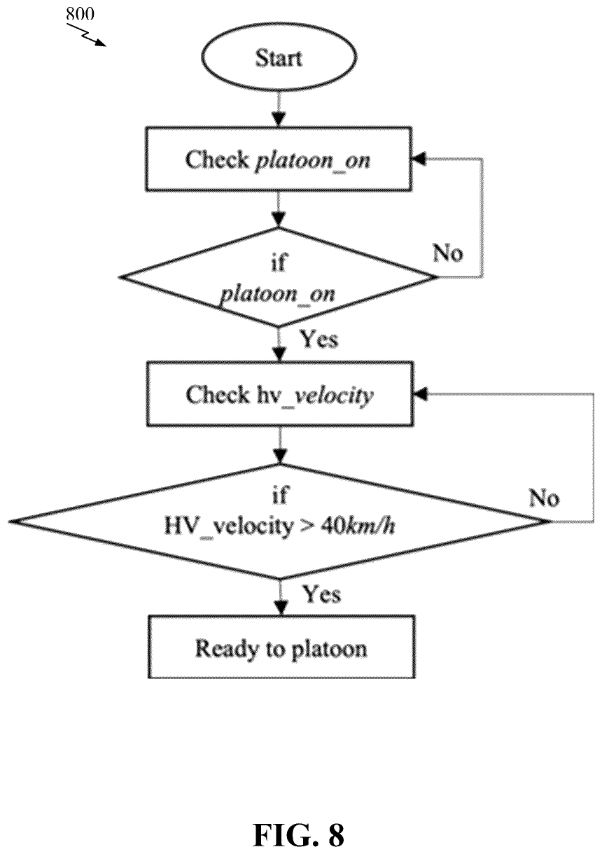

Platoon-Ready Algorithm. The platoon-ready algorithm may be deployed by software running on a vehicle, and determines if the individual vehicle is ready to platoon after certain requirements are met. Several criteria can be established to do this. The requirement used in the inventors' experiments was simply that the platooning feature be “switched on” (i.e., the driver or operator of the vehicle indicates platooning can/should be formed) and the vehicle is moving on a road at a specified speed, for example, more than 40 km/h. If these requirements are met, the vehicle is in a state suitable for platooning. Of course, in other embodiments a variety of criteria may be used for the “platoon-ready” state requirements. The flowchart depicting the platoon-ready state from the inventors' experiments is shown in FIG. 8. Once the vehicle is platoon-ready, pre-negotiation transactions occur before the actual negotiations.

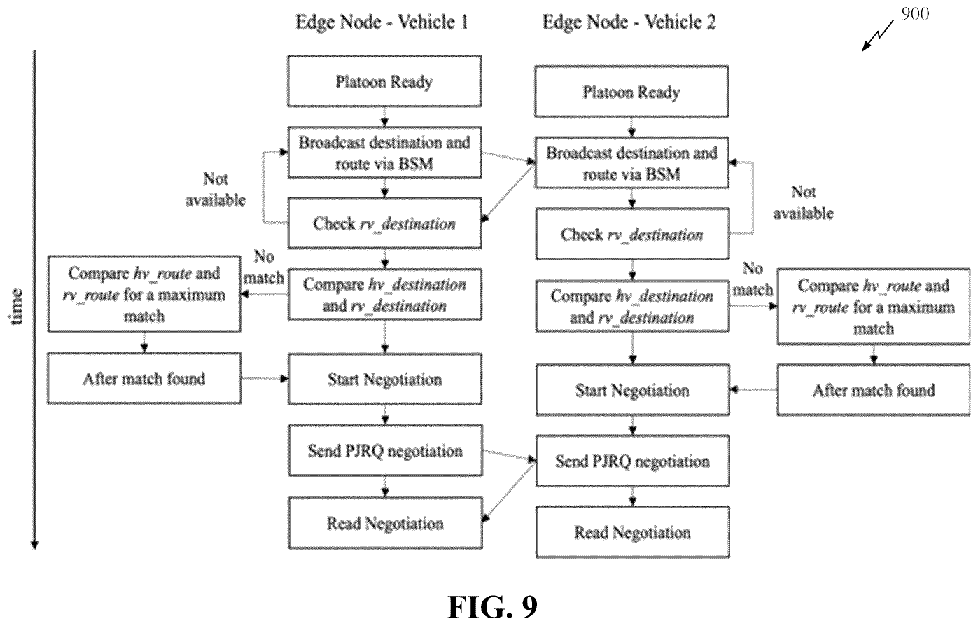

Pre-negotiation transactions. Pre-negotiation transactions take place between the vehicles through BSMs once they are platoon-ready to check if their destinations match. If the destinations are different, this algorithm evaluates their global routes to get the closest match. A negotiation is then sent to the vehicle with the matching destination once a common destination has been identified. FIG. 9 is a flowchart 900 that illustrates pre-negotiation transactions that occur between Vehicle 1 and Vehicle 2 once they are platoon-ready. Once Vehicle 1 is platoon-ready, it broadcasts its destination and path to Vehicle 2 through BSM. Vehicle 1 now constantly checks to see if Vehicle 2's destination and route are available. Once ready, Vehicle 1 compares its destination to the destination of Vehicle 2. If they do not match, their global routes are compared to identify the best possible match. After finding a match, Vehicle 1 begins negotiating by issuing a PJRQ. The same logic is executed in Vehicle 2 (shown on the right side of FIG. 9), which begins negotiating once a match is identified. Once the vehicles begin negotiating, the negotiations are handled using the negotiation resolver algorithm.

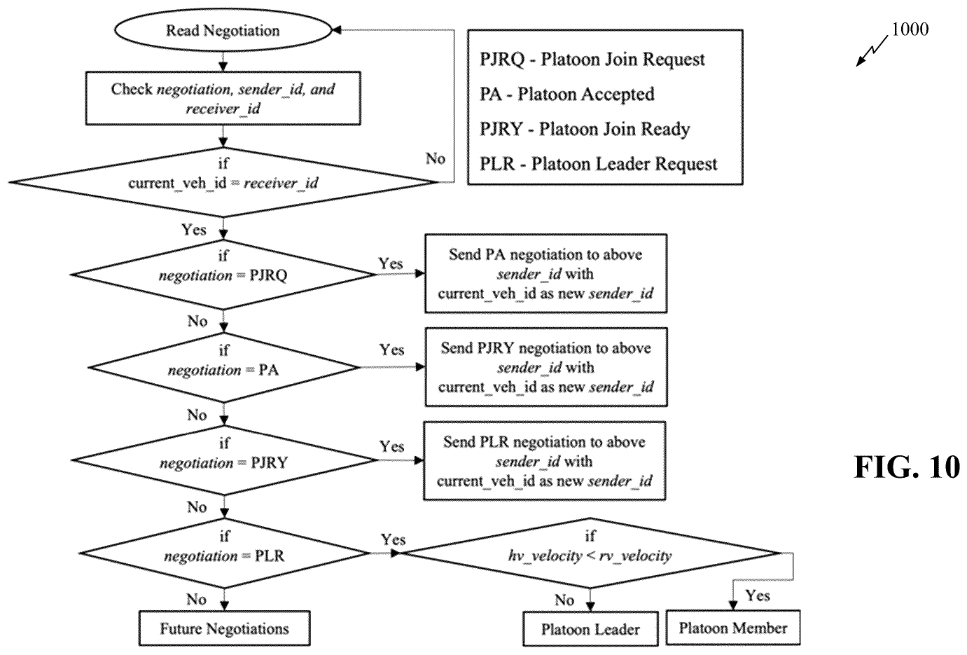

Negotiation Resolver Algorithm. The negotiation resolver algorithm resolves the negotiations between two vehicles over time as shown in FIG. 10. Once the vehicle is ready to platoon and begins to negotiate, a PJRQ negotiation is sent to other vehicles through BSMs. The negotiation structure includes a negotiation, sender_id, and receiver_id and the negotiation may be either PJRQ, PA, PJRY or PLR. Other variables sender_id and receiver_id represent HV id and RV id respectively. This way, only the vehicles interacting can process the negotiation messages. The negotiation resolver, which runs independently on each vehicle, processes negotiations received through the BSMs. As shown in FIG. 10, the resolver reads these negotiations and handles them accordingly. Vehicles process received BSMs, and when a negotiation is read from the BSM, the receiver_id in the BSM is compared to the current vehicle's id ‘current_veh_id’ or HV id that is processing the negotiation. If the current_veh_id matches the receiver_id, the received negotiation is processed further. If the negotiation is a PJRQ, the algorithm accepts it and sends a PA negotiation back to the above sender_id or RV id. The current HV id becomes the new sender_id and the RV id becomes the new receiver_id when sending a PA negotiation back. This is a similar concept to the remainder of the negotiations. Following that, if the negotiation is a PA, a PJRY negotiation is acknowledged back to the above sender_id or RV id. At this point, both vehicles have acknowledged that they are ready to form a platoon. The next negotiations would be to establish who would head the platoon. For this, we assume that each vehicle declares itself to be PL and sends PLR negotiations. If the negotiation is a PLR, the current vehicle or HV compares its velocity to that of the sender vehicle or RV during processing. If hv_velocity is less than rv_velocity, meaning that it is driving slower than the remote, it becomes a PM. The criteria set to become a PL here are arbitrary and can be changed according to the requirements of a given application or platooning goal. This way a negotiation resolver is implemented to settle the negotiations between the vehicles to initiate platooning.

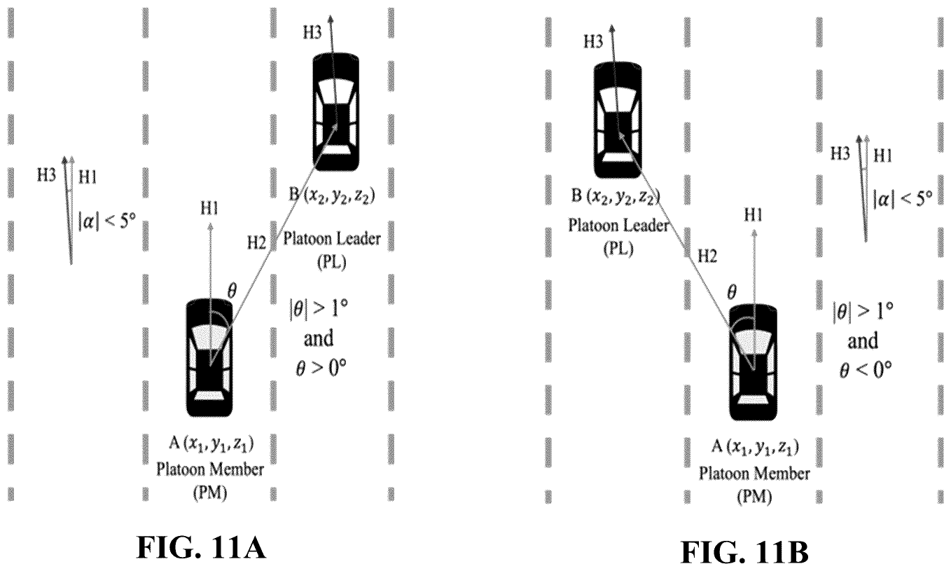

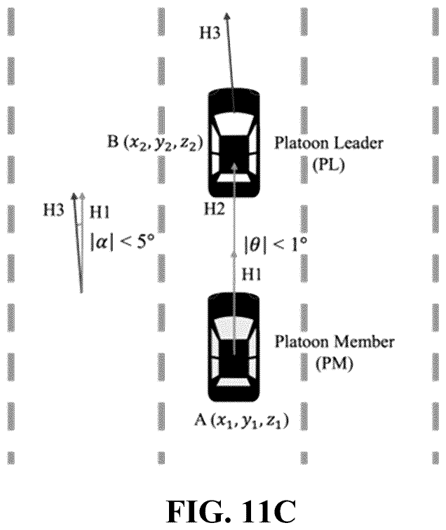

Platoon Member Algorithm. Once PM and PL are determined, this logic is used by PM to follow PL based on the relative angle ‘θ’. FIGS. 11A-C show when PL is on the right, left, and same lanes of PM respectively. As shown, H1 is the heading angle of PM, H2 is the heading angle of the new vector AB joining PM and PL, and H3 is the heading angle of PL. Relative angle θ is the difference between H1 and H2. First, the algorithm checks if both PM and PL are heading in the same direction by calculating ‘α’, the difference in their heading angles (H1-H3). When mod α is less than 5, meaning PM and PL are heading in the same direction, the relative angle θ between PM and PL is computed. PM and PL are deemed to be in the same lane when mod θ is less than 1. In this scenario, the PM will follow PL in the same lane as shown in FIG. 11C. PM and PL are in different lanes when mod θ is greater than 1. PL is on the right lane of PM when θ is positive or greater than 0. In this case, the PM will drive to its right lane to follow PL as shown in FIG. 11A. PL is on the left lane of PM when θ is negative or less than 0. Here, the PM will drive to its left lane to follow PL as shown in FIG. 11B. FIG. 12 shows the above logic in a flowchart.

### Multi-Vehicle Platooning.

Based on the inventors' experiments, the above-described algorithms perform well for two-vehicle platoons in most instances. However, as platoon size increases, more complexity in communication and coordination among the vehicles becomes a factor and can cause instability or performance that does not meet requirements. Thus, a more robust and scalable protocol was also developed to accommodate dynamic and scalable multi-vehicle platooning, which can entail use of global and local leader roles. This concept helps in organizing and coordinating the platoon's activities. Here, PL is assigned as a global leader which is responsible to oversee the entire platoon's operations such as initiating negotiations, coordinating communication, and making decisions for the platoon as a whole. On the other hand, the local leader is assigned to each individual PM to facilitate communication and coordination between global leader and its associated PM.

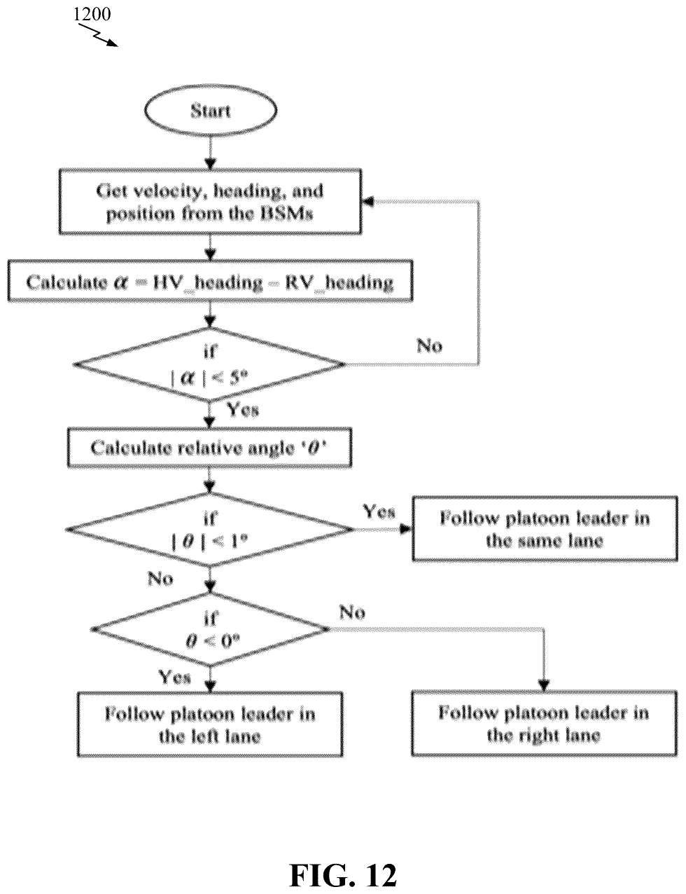

With this, there is no change to the platoon-ready algorithm while pre-negotiation, negotiation resolver, and platoon member algorithms are updated to support multi-vehicle platooning. Also, we renamed the “Platoon Member” algorithm to the “Platoon Formation” algorithm to accurately reflect the expanded functionality of this algorithm, which now encompasses the broader platoon formation process. The relationship between these algorithms and the order in which they are executed is illustrated in FIG. 13. Using these, two vehicles can negotiate and start a platoon where we assign PL as the global and the local leader for the first PM. Once the platoon is complete between these two vehicles, the PL makes itself available to negotiate with nearby vehicles. Any future PM can now negotiate with this PL to join its platoon. After their negotiations, we assign PL as the global leader and the existing PM as the local leader to the newly joined PM. A clear explanation of each of the updated algorithms is presented in this section.

When the vehicles are platoon-ready (as described above), they broadcast their intent to platoon through BSM containing their destination and route. When nearby vehicles receive BSMs, they check if the vehicle that sent the BSM is platoon-ready and willing to platoon. If yes, their destinations are compared to check if they both are traveling to the same destination. If their destinations do not match, a maximum global match is found. Once a common destination (or route path segment) is identified, the vehicles check if the RV is available for negotiation. If the RV is available to negotiate, the HV then checks if there is an active platoon. If there is no active platoon, HV marks itself as busy and starts negotiating. If there is an active platoon, HV waits until it receives a BSM from PL of the active platoon, marks itself as busy, and starts to negotiate with PL.

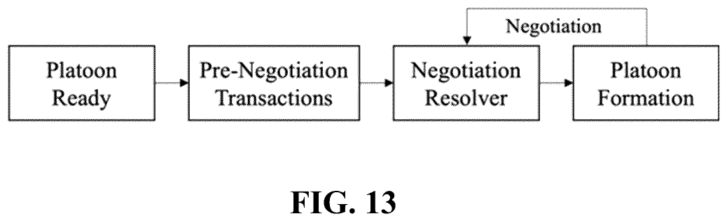

Pre-negotiation transactions happening between edge nodes Vehicle 1 and Vehicle 2 over time are depicted in detail in FIG. 14 after they are platoon-ready. Vehicle 1 broadcasts its destination and route to Vehicle 2 through a BSM and continuously checks if the destination and route for Vehicle 2 are available through incoming BSMs. When available, Vehicle 1 compares both destinations to find a common match. If a common destination is present, Vehicle 1 checks if Vehicle 2 is available to negotiate. If available, then it checks if there is an active platoon system. If an active platoon is present, it checks if Vehicle 2 is a platoon leader. If Vehicle 2 is not a leader, Vehicle 1 changes its status to busy and starts to negotiate by sending a Platoon Join Request (PJRQ) negotiation. Vehicle 2, which is shown on the right side of FIG. 14, follows the same logic and begins negotiating as soon as a common destination is identified and status is available. The negotiation resolver algorithm, which is described below, is used to resolve the negotiations.

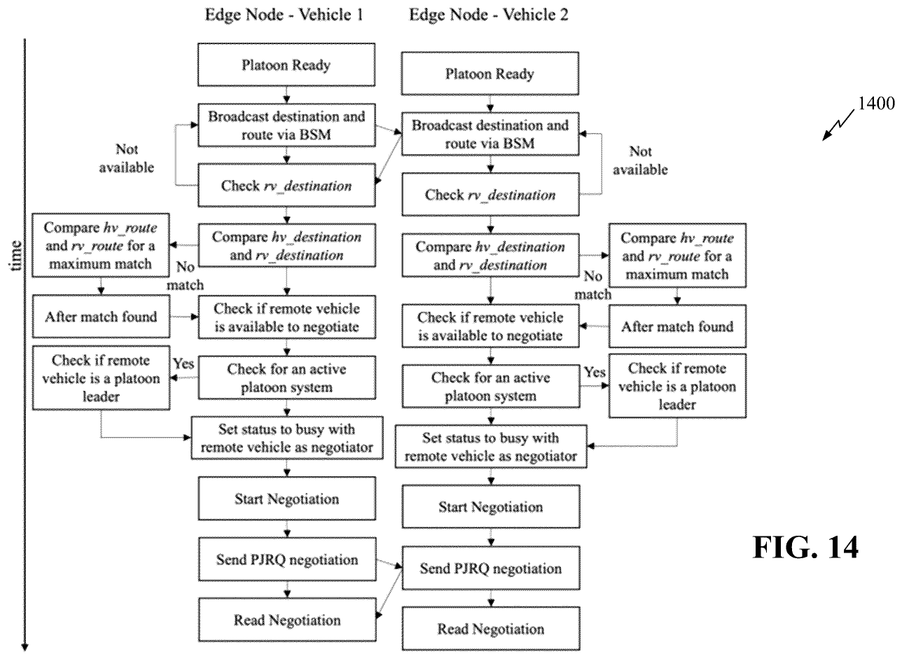

Multi-Vehicle Negotiation Resolver Algorithm. At a high level, the negotiation resolver executes three types of logic. The first type resolves negotiations between two vehicles to initialize a non-existing platoon. Once initialized, the other two support negotiations between PL and any future PMs and vice versa. For this, we initialize ‘join_ready’, ‘active_platoon’, and ‘leader’ variables to false. Here, join_ready is set to true after successful platoon negotiations for all vehicles, active_platoon to true once there is any active PL, and leader is set to true for PL. Variables ‘global_leader’ and ‘local_leader’ are initialized to ‘None’ where global_leader will be set to PL and local_leader as the last joined PM in the platoon. Lastly, variables ‘member_list’ and ‘member_count’ are set to ‘None’ that are used by PL to track PMs. Note that the same algorithm runs in every vehicle and logic is executed based on the situation. With this background, we now explain the negotiation resolver algorithm as shown in FIG. 15.

After pre-negotiation transactions, the vehicle marks itself busy and will not accept negotiations from any vehicles other than the vehicle it is negotiating with. We now assume that there is no active platoon and two vehicles are exchanging IoT-based BSMs containing vehicle information accompanied by a negotiation. Now, the negotiation resolver running independently in each vehicle processes the BSM and reads the negotiation. The structure of the negotiation contains a ‘negotiation’, ‘sender_id’, ‘receiver_id’, ‘is_leader’, and ‘pm_list’ where a vehicle with id ‘sender_id’ is sending a negotiation ‘negotiation’ to a vehicle with id ‘receiver_id’. Here, is_leader indicates whether the vehicle sending the negotiation is a platoon leader or not and pm_list contains the list of PMs that can be used by a future PM to find its local leader.

After receiving and reading the negotiation, the algorithm checks if the negotiation is intended for the current vehicle. If it is, then it checks for the variable join_ready. Since this variable is initialized to false, the algorithm checks for the variables is_leader from negotiation and active_platoon. Since these two variables will be false initially, negotiations are carried out until one of them becomes a PM and the other PL. For PM, PL is assigned as the global_leader and local_leader while join_ready is set to true. For PL, PM is added to the member_list, member_count incremented by one, and variables join_ready and leader are set to true. Using the platoon formation algorithm presented in Section 4.2.3, PM joins in PL's lane and then sends a Platoon Complete (PC) negotiation to the PL. When PL receives this negotiation and processes, it enters into a second type of logic from here onwards since join_ready is set to true. Here, if the negotiation is PC, PL marks itself as available to negotiate with nearby vehicles.

The new vehicle that is willing to platoon sets active_platoon to true if there is an active platoon and initializes pre-negotiation transactions. If their destinations match, the new vehicle sets itself busy and sends a PJRQ negotiation to the leader. When PL receives this negotiation, the algorithm sends a Platoon Accept (PA) negotiation back to the new vehicle along with leader as true. When the new vehicle receives this negotiation, the negotiation resolver enters into the third type of logic since there is already an active platoon and the negotiation is from the leader itself. If the received negotiation is PA, a Platoon Join Ready (PJRY) negotiation is sent back to PL. When PL receives PJRY negotiation, it adds the new vehicle into its member_list and sends a PJRY negotiation back. If the new vehicle receives PJRY as negotiation, it sets itself as platoon member, global_leader as PL, local_leader as last joined PM before it from pm_list, and sets join_ready to true. Using the platoon formation algorithm, a new PM joins the platoon and sends a PC negotiation back to PL. Any future vehicle can join an existing platoon similarly using the second and third types of logic.

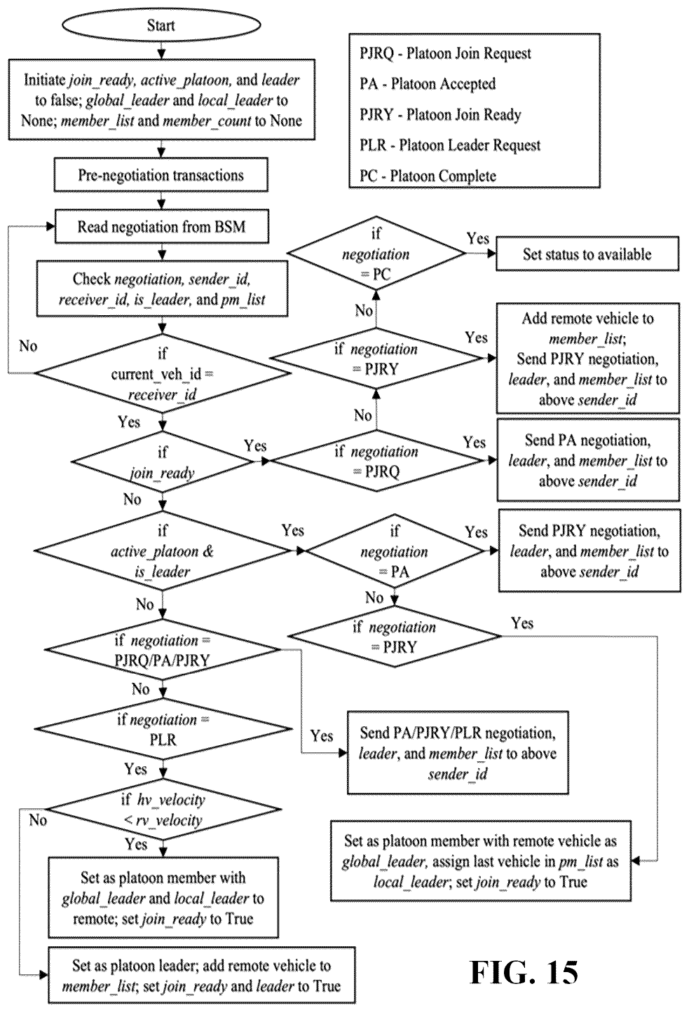

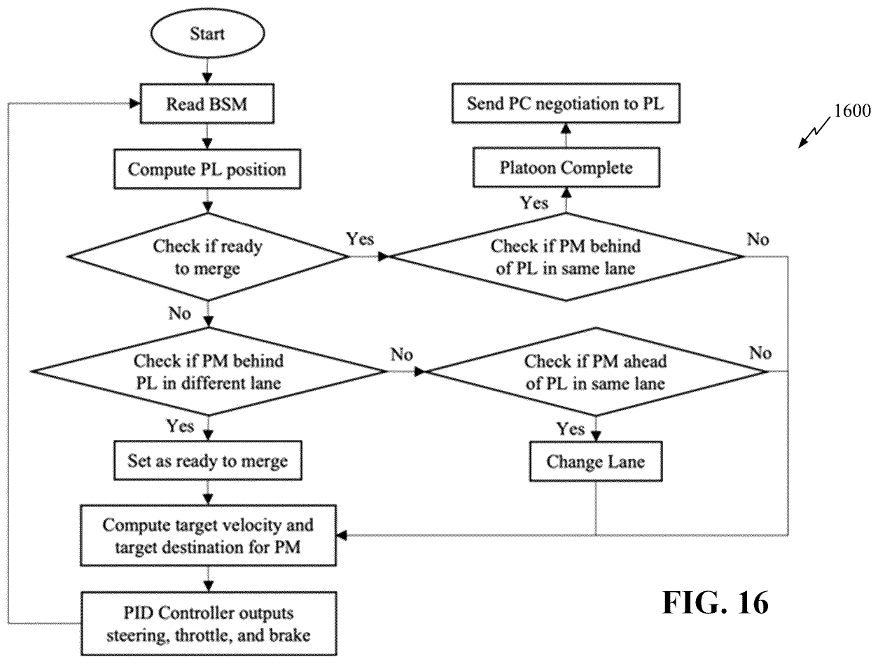

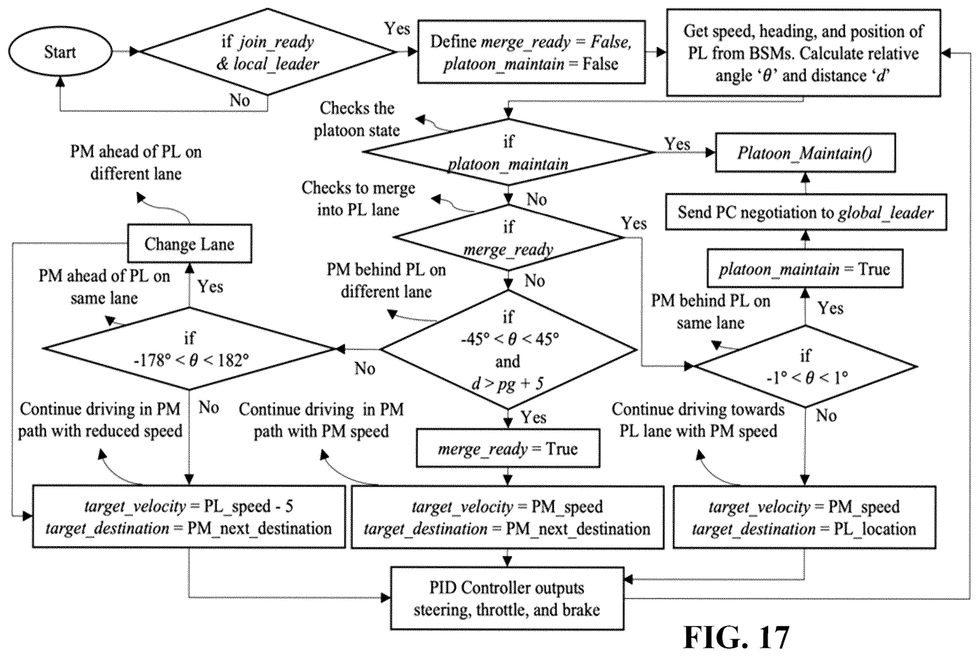

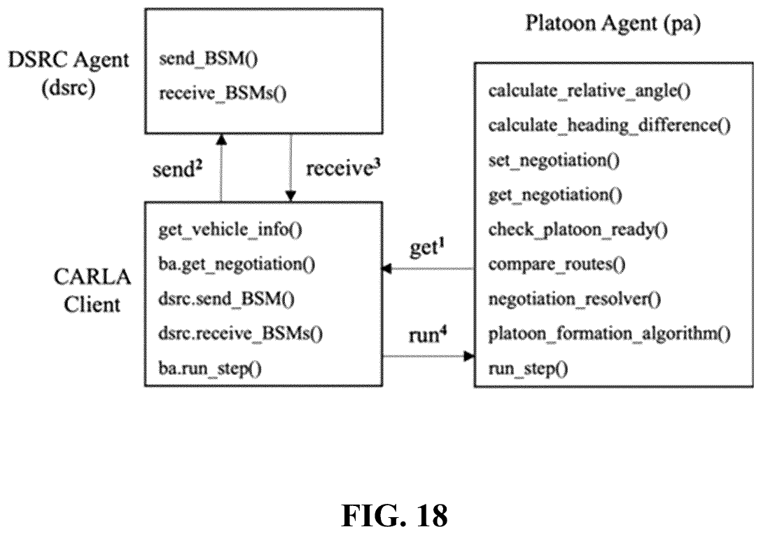

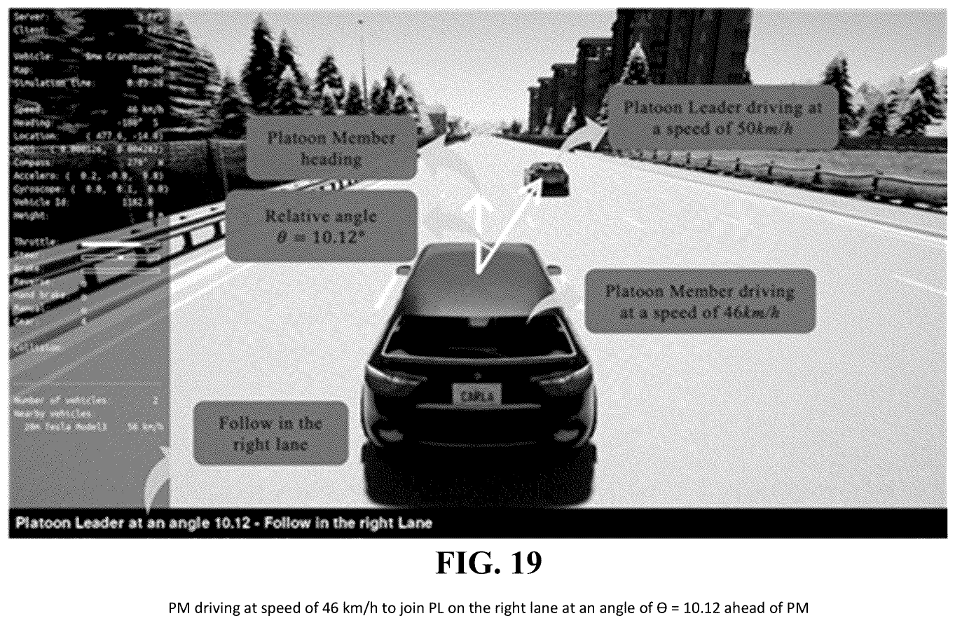

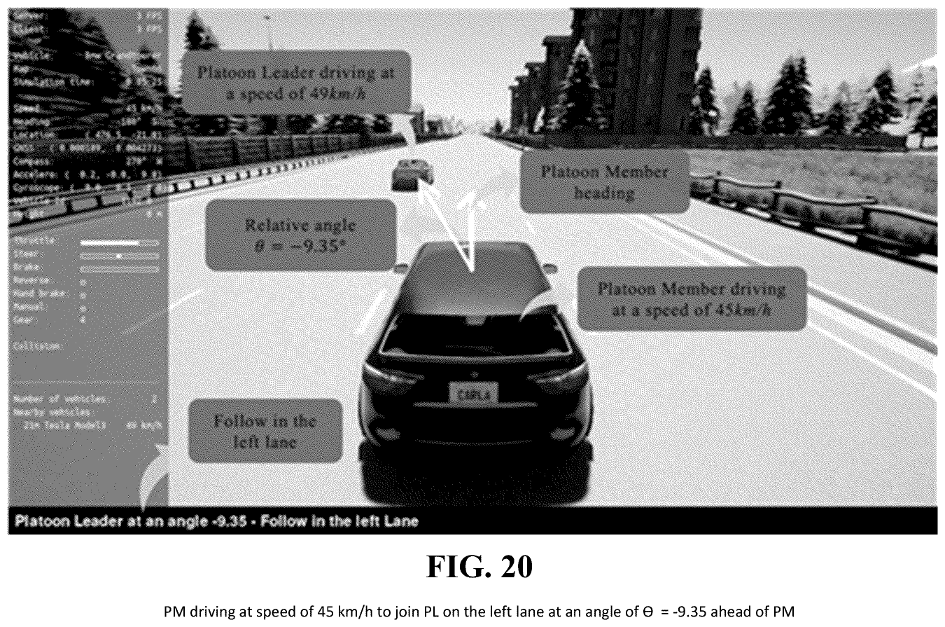

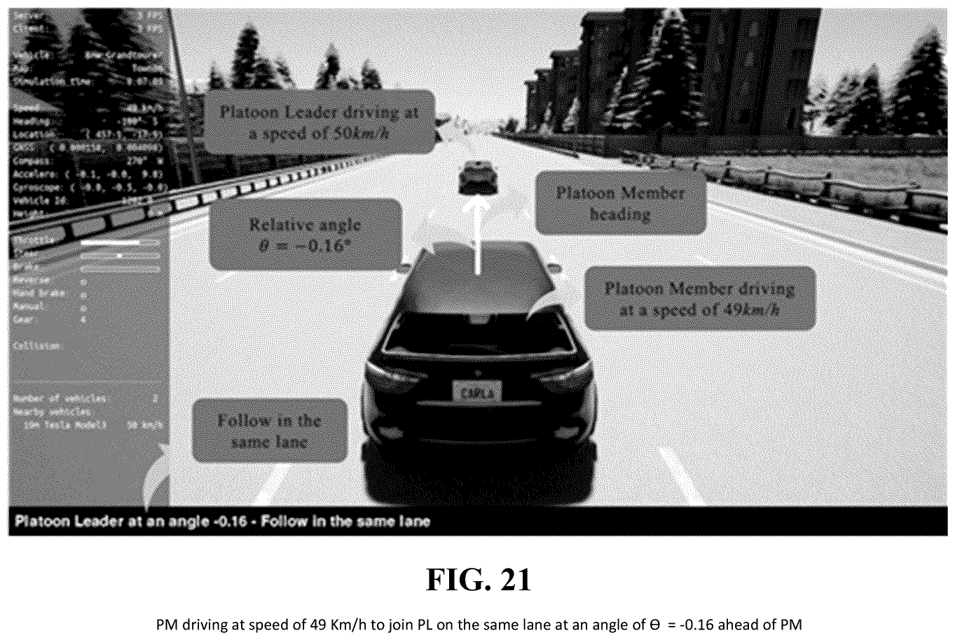

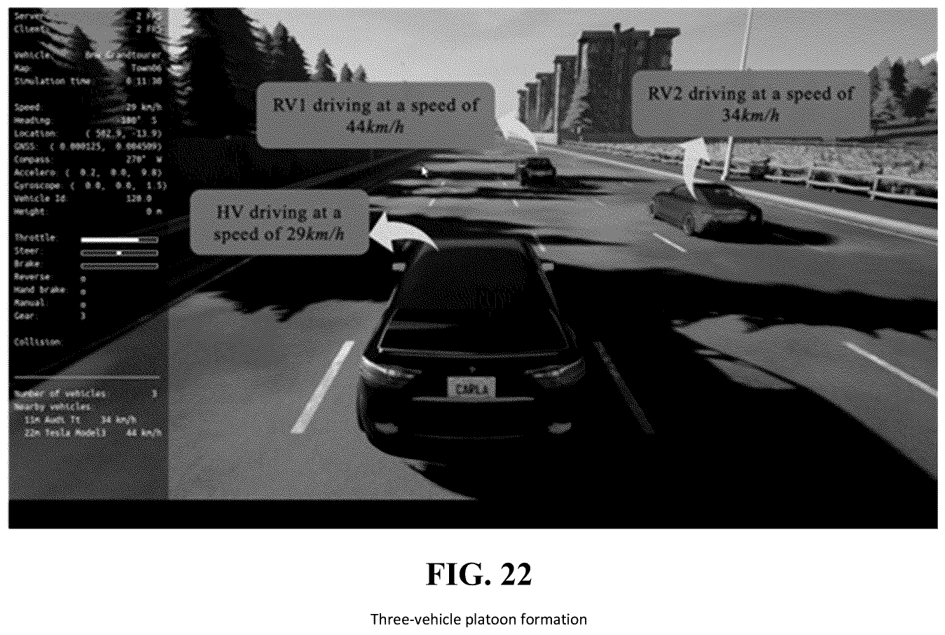

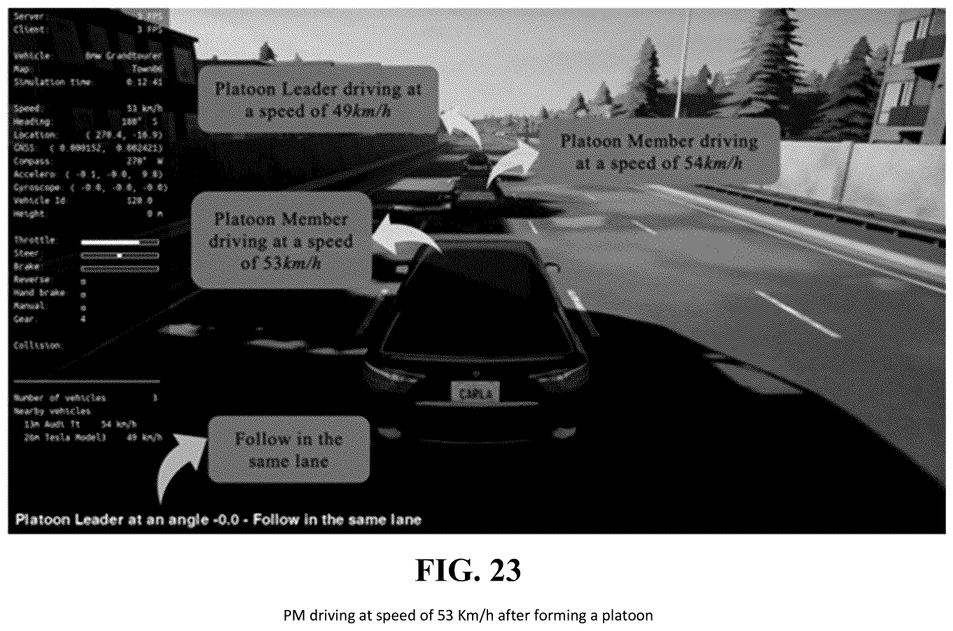

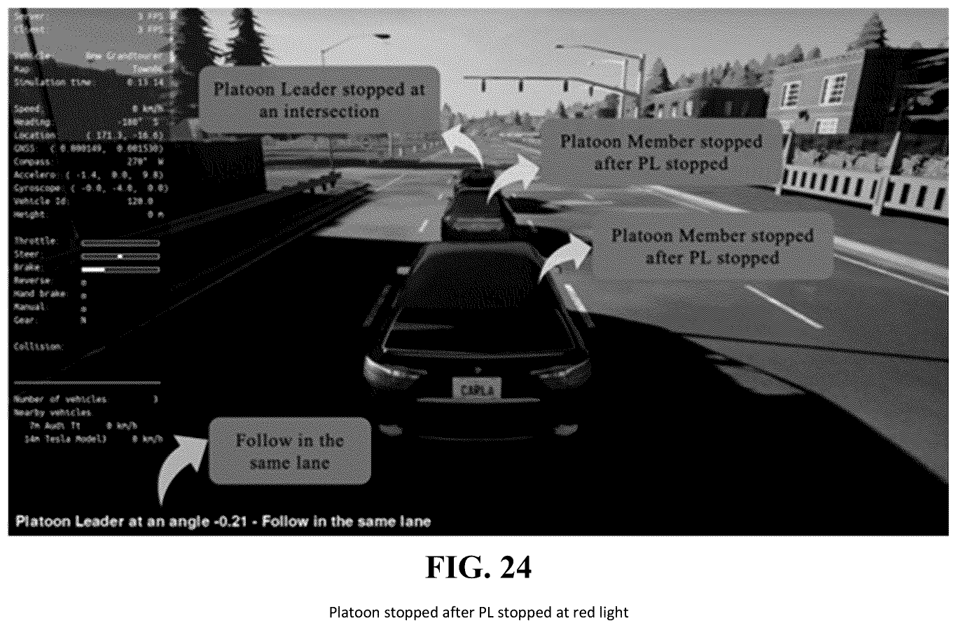

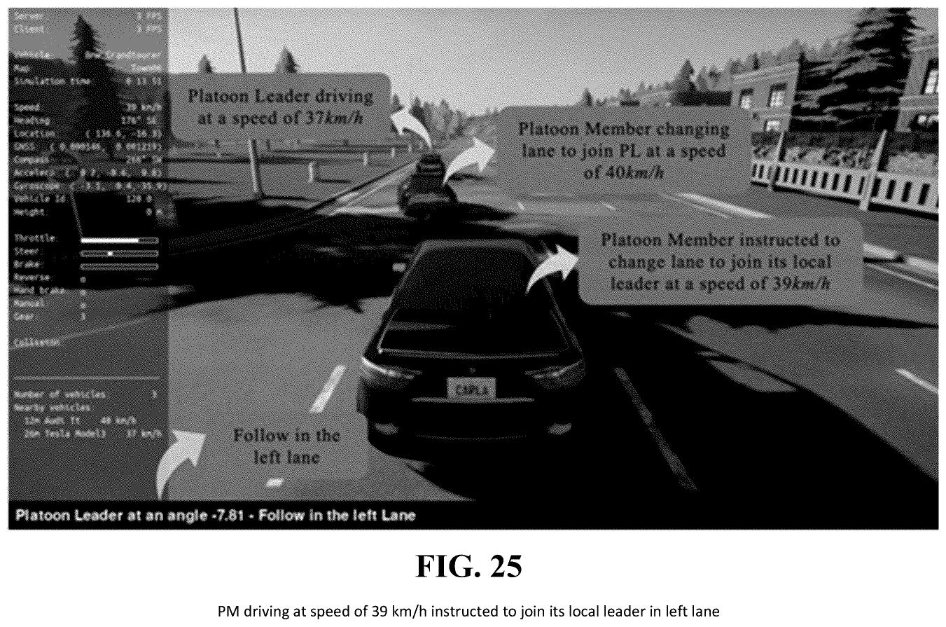

Multi-Vehicle Platoon Formation Algorithm. Once PM and PL are determined, PM uses the platoon formation algorithm shown in FIG. 16 to join the PL with more technical details provided in FIG. 17. This algorithm checks if a PM is join_ready and that the received BSM is from its local_leader. After verifying, PM joins PL in its lane as discussed above. Once PM reaches the platoon_maintain state, it sends a PC negotiation to the global leader. These are the changes made to the platoon formation algorithm to support multi-vehicle platooning.

The platoon-maintain state may include the global PL continuously tracking the positions and statuses of all PMs using data from BSMs. In some protocols contemplated in the inventors' work, the PL may itself calculate the relative positions and statuses (e.g., speeds, etc.) from BSMs directly, and in other protocols the PL may also receive confirmation or supplemental information on PM position and statuses from other, neighboring PMs that are also monitoring the platoon. The PL will also use its own onboard autonomy systems, such as adaptive cruise control and autonomous driving functions to adjust its speed relative to vehicles ahead of the PL in the same lane. As the PL adjusts its own speed, it may send a BSM with its updated speed (or an instruction to update speed) to the PMs, so the PMs can adjust in synchrony to the PL. Thus, string stability can be maintained. For example, cooperative adaptive cruise control may be utilized. Similarly, as the PL determines a lane change should occur (e.g., because the PL's autonomous driving function determines a lane change should occur, or a driver/operator of the PL initiates a lane change, the PL may send a rapid series of updated BSMs with its heading changes and/or instructions to change lanes to the PMs (e.g., to the local leaders or all PMs).

PMs may use their own onboard systems to maintain speed and distance relative to the vehicle ahead of it (e.g., a local or global leader, or another PM) and remain within a lane, such as via its native adaptive cruise control and lane keeping functions. The PM may also periodically receive updated BSM information or instructions from a local leader or global PL to adjust its lane, distance, or speed, or to relay messages to other platoon members.

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A host vehicle configured to implement dynamic and scalable platooning, the host vehicle comprising:
a user interface;
a local communication transceiver;
at least one environment sensor affixed to the host vehicle so as to monitor the host vehicle's surroundings for nearby objects;
a processor;
a drive autonomy controller connected to control at least one of a steering system or an acceleration system of the host vehicle in response to instructions from the processor; and
a memory having stored thereon software which, when executed by the processor, causes the host vehicle to:
determine a platoon readiness state of the host vehicle;
broadcast a platoon intent message via the local communication transceiver;
receive a platoon intent message from a first nearby vehicle via the local communication transceiver;
determine whether to form a platoon with the first nearby vehicle, based on: at least one platoon suitability requirement; information sent by the first nearby vehicle regarding a drive status of the first nearby vehicle; and information stored on the memory regarding current status of the host vehicle;
when the determination indicates that a platoon with the first nearby vehicle should be formed, negotiate a platoon structure with the first nearby vehicle, the platoon structure comprising:
which of the host vehicle or first nearby vehicle will be platoon leader of the platoon;
an acceptable speed for the platoon;
an acceptable intervehicle distance for the platoon;
a common route for the platoon; and
a setting indicative of whether the platoon will accept future additional members; and
when the determination indicates that a platoon with the first nearby vehicle should not be formed, resume broadcasting the platoon intent message via the local communication transceiver.

2. The host vehicle of claim 1, wherein the software further causes the host vehicle to:
operate as the platoon leader as a result of negotiating the platoon structure with the first nearby vehicle; and
while the platoon structure remains in place between the host vehicle as platoon leader and the first nearby vehicle as a platoon member, broadcast a message indicative of availability to platoon to additional nearby vehicles.

3. The host vehicle of claim 1, wherein the software further causes the host vehicle to:
receive a platoon intent message via the local communication transceiver from a second nearby vehicle;
determine whether to admit the second nearby vehicle to the platoon structure as a platoon member, based on based on: the at least one platoon suitability requirement; information sent by the second nearby vehicle regarding a status of the second nearby vehicle; and information stored on the memory regarding the platoon structure;
when the determination indicates that the second nearby vehicle should be joined to the platoon structure, broadcast platoon joining instructions to the second nearby vehicle and update information in the memory regarding the platoon structure to account for membership and status of the second nearby vehicle; and
monitor at least one of a speed, heading, or relative distance of each of the first nearby vehicle and the second nearby vehicle based on messages received via the local communication transceiver.

4. The host vehicle of claim 3, wherein the software further causes the host vehicle to:
determine a change to be made in a drive characteristic of the host vehicle based on data received from the at least one environment sensor;
generate an instruction for the drive autonomy controller to effectuate the change in drive characteristic for the host vehicle; and
broadcast a message to the first nearby vehicle and to the second nearby vehicle via the local communication transceiver, indicating the vehicles should make a corresponding change in their own drive characteristics.

5. The host vehicle of claim 2, wherein the software further causes the host vehicle to determine which of the first nearby vehicle and second nearby vehicle should be designated as a local leader, based on a comparison of drive characteristics of the first nearby vehicle and second nearby vehicles and a comparison of sensing capabilities of the first nearby vehicle and the second nearby vehicle.

6. The host vehicle of claim 3, wherein the software further causes the host to resume broadcasting the message indicative of availability to platoon to additional nearby vehicles, while the platoon structure including the first nearby vehicle and second nearby vehicle remains in place.

7. The host vehicle of claim 6, wherein the software further causes the host vehicle to monitor for an indication of whether the first nearby vehicle or second nearby vehicle should exit the platoon structure, the indication comprising at least one of:
a platoon exit message broadcast by one of the first nearby vehicle or the second nearby vehicle and received via the local communications transceiver; and
a determination that one of the first nearby vehicle or the second nearby vehicle has altered its drive characteristics so as to no longer remain in platoon formation.

8. The host vehicle of claim 6, wherein the software further causes the host vehicle to, in response to an indication that the first nearby vehicle should exit the platoon structure, sending a new platoon position message to the second nearby vehicle via the local communications transceiver, and updating the information stored in the memory regarding platoon status to account for the first nearby vehicle no longer being in a platoon with the host vehicle.

9. The host vehicle of claim 6, wherein the software further causes the host to receive a platoon intent message from a third nearby vehicle, and if a determination is made that the third nearby vehicle should be admitted to the platoon structure:
send a platoon join message to the third nearby vehicle;
determine whether the third nearby vehicle or the second nearby vehicle should be a local leader; and
update the information stored in the memory regarding platoon structure to account for admission of the third nearby vehicle.

10. The host vehicle of claim 9, wherein the software further causes the host vehicle to determine that the host vehicle should no longer be a part of the platoon structure based on at least one of:
an input from an operator of the host vehicle;
an assessment of unacceptable drive characteristics of one or more other members of the platoon structure, based on predefined criteria; or
data concerning a weather condition.

11. The host vehicle of claim 10, wherein the software further causes the host vehicle to broadcast a message via the local communications transceiver to the second nearby vehicle and the third nearby vehicle indicating that the host vehicle will no longer serve as platoon leader and causing the second nearby vehicle and third nearby vehicle to commence negotiations to determine which should serve as a new platoon leader of the platoon structure.

12. A method for dynamically creating and scaling a vehicle platoon formation, comprising:
determining a platoon-ready status of a first vehicle, while the first vehicle is driving on a route segment;
broadcasting a platoon intent message via a DSRC transmission;
receiving a response to the platoon intent message from a second vehicle;
negotiating a platoon formation via communications directly between the first vehicle and second vehicle over DSRC transmissions, the platoon formation defining a platoon leader and a platoon member from among the first vehicle and second vehicle;
broadcasting a platoon available message via a DSRC transmission;
receiving a response to the platoon available message from a third vehicle;
determining whether the third vehicle should be admitted to the platoon formation, based on information regarding a status of the third vehicle and the route segment;
if a determination is made that the third vehicle should be admitted to the platoon formation, broadcasting a platoon join instruction to the third vehicle via a DSRC transmission, and:
designating a vehicle member of the platoon formation as a local leader;
instructing another vehicle member of the platoon formation to perform a maneuver to commence following the local leader; and
if a determination is made that the third vehicle should not be admitted to the platoon formation, broadcasting a message to the third vehicle declining to admit the third vehicle to the platoon formation, and continuing to broadcast the platoon available message.
